(19) United States
(12) Patent Application Publication
(10) Pub. No.: US 2026/0215419 A1
(43) Pub. Date: Jul. 30, 2026

(54) PLANT EXTRACTS WITH HERBICIDAL ACTIVITY

(71) Applicant: Agrematch Ltd., Rehovot (IL)

(72) Inventors: Or BROSHI, Rehovot (IL); Yaniv MIZRAHI, Hadera (IL); Yosef GEVA, Hatzor Ashdod (IL); Yael PHILLIP, Nes-Ziona (IL)

(73) Assignee: Agrematch Ltd., Rehovot (IL)

(21) Appl. No.: 19/146,231

(22) PCT Filed: Jan. 8, 2024
(86) PCT No.: PCT/IL2024/050025

§ 371 Date: Jul. 8, 2025

Related U.S. Application Data
(60) Provisional application No. 63/437,707, filed on Jan. 8, 2023.

(51) Int. Cl. A01N 37/42; A01N 65/24; A01N 65/30; A01P 13/00

(52) U.S. Cl. CPC A01N 37/42; A01N 65/24; A01N 65/30; A01P 13/00

(57) ABSTRACT

Plant extracts enriched with Rhein and/or a glycosylated derivative thereof, which exhibit at least a herbicidal activity, processes of preparing same, and uses thereof, are provided.

### RELATED APPLICATION/S

This application claims the benefit of priority under 35 USC § 119 (e) of U.S. Provisional Patent Application No. 63/437,707 filed on Jan. 8, 2023, the contents of which are incorporated herein by reference in their entirety.

### FIELD AND BACKGROUND OF THE INVENTION

The present invention, in some embodiments thereof, relates to crop protection and, more particularly, but not exclusively, to compositions usable in promoting growth of plants by inhibiting growth of herbs and/or pests, to methods employing such compositions, and to processes of preparing such compositions.

Weeds are plants that compete with cultivated plants in an agronomic environment. Weeds also serve as hosts for crop diseases and insect pests. The losses caused by weeds in agricultural production environments include decreases in crop yield, reduced crop quality, increased irrigation costs, increased harvesting costs, reduced land value, injury to livestock, and crop damage from insects and diseases harbored by the weeds. Herbicidal compositions are the cornerstone of crop protection and the largest segment in the global agricultural chemicals market.

Herbicide tolerant weeds (e.g., PS II inhibitor-resistant weeds) are a problem with nearly all herbicides in use. There are over 350 weed biotypes identified as being herbicide resistant to one or more herbicides by the Herbicide Resistance Action Committee (HRAC), the North American Herbicide Resistance Action Committee (NAHRAC), and the Weed Science Society of America (WSSA).

The environmental effects of the currently used herbicides is still under investigation. A number of alternative herbicides comprising natural products have been used.

Anthraquinones, or anthraquinone derivatives, have been described in the art as exhibiting certain phytotoxic effects.

U.S. Pat. No. 10,470,466 describes formulations containing anthraquinone derivatives derived from Reynoutria sachalinensis root with increased effectiveness as pesticides. This document describes various optional formulations, and teaches that a suitable formulation is selected in accordance with the plant extract at hand. This document teaches that anthraquinone derivatives such as rhein, emodin, aloe emodin, parietin (physcion), emodin glycoside, physcion glycoside, chrysophanol and chrysophanol glycoside were shown to induce plant resistance to pathogens.

For the purpose of limiting the use of herbicides such as glyphosate and glufosinate phosphine, CN 107581201 describes a herbicidal composition formulated with glyphosate- and glufosinate-based composition comprising L-alpha-terpineol and traditional Chinese medicine as additives, for the reduction of the quantity of glyphosate and glufosinate in the herbicidal formulation. This document does not specify the role of the Chinese medicine, while it teaches that the combination of glyphosate and glufosinate with L-alpha-terpineol resulted in a synergistic herbicidal activity.

CN 106614788 discloses a glufosinate-based herbicide composition comprising lythidathion and Radix Et Rhizoma Rhei extract as additives.

WO 2021/013691 discloses a broad-spectrum herbicide comprising plant extracts of rhubarb leaf, yew, and black bryony. This document further describes adding oxalic acid to the formulation when the concentration thereof is low in the rhubarb leaves. It is stated that all the active ingredients are poisonous to humans and other animals upon digestion.

Rhein, also known as cassic acid, and its glycosylated derivative, the structures of which are shown below, are anthraquinones which are common metabolites in various plants. It is found in common traditional Chinese medicinal herbs, e.g., Rheum palmatum and has been reported as exhibiting hepatoprotective, nephroprotective, anti-oxidative, anti-cancerous, and antimicrobial effects (see, review in Zhou et al., Evidence-Based Complementary and Alternative Medicine, 2015, Article ID 578107).

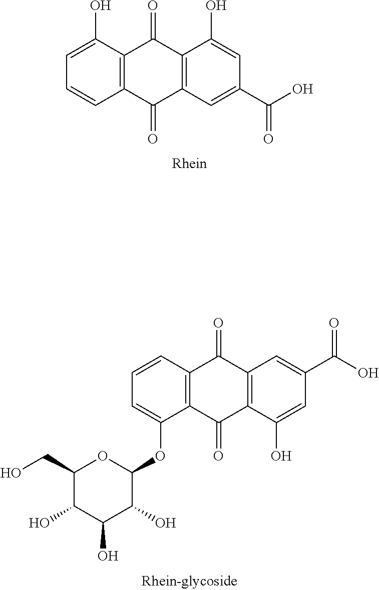 [SMILES: O=C(O)c1cc(O)c2c(c1)C(=O)c1cccc(O)c1C2=O ; O=C(O)c1cc(O)c2c(c1)C(=O)c1cccc(O[C@@H]3O[C@H](CO)[C@@H](O)[C@H](O)[C@H]3O)c1C2=O]

Additional background art includes Cao et al. [Water Sci Technol (2020) 82 (6), 1092-1101; Oettmeier et al., FEBS Letters, 1988, Volume 231, No. 1, pages 259-262; Schrader et al., Int. J. Plant Sci. 161 (2): 265-270, 2000; Andolfi et al., J. Agric. Food Chem. 2013, 61, 7301-7308; GB Patent No. 1,382,721; DeLiberto and Werner, Pest Manag Sci 2016; 72:1813-1825; and PCT International Patent Application Publication No. WO 2023/281509.

### SUMMARY OF THE INVENTION

According to an aspect of some embodiments of the present invention there is provided a plant extract comprising an aqueous extraction medium and at least one anthraquinone compound extracted from the plant, wherein at least 50%, or at least 70%, or at least 80% of a total amount of the at least one anthraquinone consist of Rhein and/or the glycosylated derivative thereof.

According to some of any of the embodiments described herein, the plant is Rheum palmatum.

According to some of any of the embodiments described herein, the plant extract is obtainable from a root of Rheum palmatum.

According to some of any of the embodiments described herein, the plant is Cassia fistula.

According to some of any of the embodiments described herein, the plant extract is obtainable from a pulp of Cassia fistula.

According to some of any of the embodiments described herein, the plant is Cassia angustifolia.

According to some of any of the embodiments described herein, the plant extract is obtainable from a leaf of Cassia angustifolia.

According to some of any of the embodiments described herein, the plant extract is obtainable upon contacting the plant or a part thereof with the aqueous extraction medium.

According to some of any of the embodiments described herein, the contacting is of a single plant or of a part of the single plant (e.g., a single part of a single plant).

According to some of any of the embodiments described herein, the aqueous extraction medium comprises a polar organic solvent, preferably an alcohol (a hydroxy-containing organic solvent).

According to some of any of the embodiments described herein, the polar organic solvent (e.g., alcohol) is an amine-containing compound (e.g., an amine-substituted alcohol).

According to some of any of the embodiments described herein, the amine-containing compound is mono-isopropanol amine (MIPA).

According to some of any of the embodiments described herein, a concentration of the amine-containing compound in the aqueous extraction medium ranges from about 0.1 to about 10, or from about 0.1 to about 5, or from about 1 to about 10, or from about 1 to about 5, % by volume, of the total volume of the extraction medium, including any intermediate values and subranges therebetween.

According to some of any of the embodiments described herein, the aqueous extraction medium further comprises at least one water-soluble or water-miscible organic solvent.

According to some of any of the embodiments described herein, the at least one organic solvent is selected from a ketone, a sulfoxide and a combination thereof.

According to some of any of the embodiments described herein, a total amount of the at least one solvent ranges from about 1 to about 20, or from about 1 to about 10, % by volume, of the total volume of the aqueous extraction medium, including any intermediate values and subranges therebetween.

According to some of any of the embodiments described herein, the aqueous extraction medium further comprises at least one adjuvant.

According to some of any of the embodiments described herein, a total amount of the at least one adjuvant ranges from about 0.1 to about 5, or from about 1 to about 5, or from about 1 to about 3%, by volume, of the total volume of the aqueous solution, including any intermediate values and subranges therebetween.

According to some of any of the embodiments described herein, the plant extract is capable of controlling (e.g., inhibiting) a growth of a herb.

According to an aspect of some embodiments of the present invention there is provided a process of preparing a plant extract that comprises at least one anthraquinone and an aqueous extraction medium, wherein at least 50%, or at least 70%, or at least 80% of a total amount of the at least one anthraquinone consist of Rhein and/or a glycosylated derivative thereof, the process comprising contacting a root of Rheum palmatum (e.g., as a single plant source) with the aqueous extraction medium.

According to some of any of the embodiments described herein, the aqueous extraction medium comprises a polar organic solvent, preferably an alcohol (a hydroxy-containing organic solvent), which further comprises an amine (an amine-containing compound such as an amine-substituted alcohol, e.g., MIPA).

According to some of any of the embodiments described herein, the extraction medium further comprises at least one water-soluble or water-miscible organic solvent such as described herein and/or at least one adjuvant such as described herein.

According to some of any of the embodiments described herein, the process further comprises grinding the root of Rheum palmatum, prior to contacting it with the aqueous extraction medium.

According to an aspect of some embodiments of the present invention there is provided a process of preparing a plant extract that comprises Rhein and/or a glycosylated derivative thereof and an aqueous extraction medium, wherein at least 50%, or at least 70%, or at least 80% of a total amount of the at least one anthraquinone consist of Rhein and/or the glycosylated derivative thereof, the process comprising contacting a plant or a part thereof with the aqueous extraction medium, the extraction medium comprising a polar organic solvent, preferably an alcohol (a hydroxy-containing organic solvent), which further comprises an amine (an amine-containing compound, such as an amine-substituted alcohol, e.g., MIPA).

According to some of any of the embodiments described herein, the extraction medium further comprises at least one water-soluble or water-miscible organic solvent such as described herein and/or at least one adjuvant such as described herein.

According to some of any of the embodiments described herein, the contacting is with a single plant or with a part of a single part (e.g., with a single part of a single plant).

According to some of any of the embodiments described herein, the single plant is Rheum palmatum.

According to some of any of the embodiments described herein, the contacting is with a root of Rheum palmatum (e.g., in a form of a powder).

According to some of any of the embodiments described herein, the plant is Cassia fistula. According to some of any of the embodiments described herein, the contacting is with a pulp of Cassia fistula (e.g., in a form of a powder).

According to some of any of the embodiments described herein, the plant is Cassia angustifolia.

According to some of any of the embodiments described herein, the contacting is with a leaf of Cassia angustifolia.

According to some of any of the embodiments described herein, the contacting is at room temperature.

According to some of any of the embodiments described herein, the process further comprises grinding the plant or the part thereof, prior to contacting it with the aqueous extraction medium.

According to an aspect of some embodiments of the present invention there is provided a plant extract obtainable by the process as described herein in any of the respective embodiments and any combination thereof.

According to an aspect of some embodiments of the present invention there is provided a composition comprising the plant extract as described herein in any of the respective embodiments and any combination thereof, and optionally further comprising an agriculturally acceptable carrier.

According to some of any of the embodiments described herein, the composition is a herbicidal composition.

According to some of any of the embodiments described herein, the composition is for use in controlling (e.g., inhibiting) a growth of a herb.

According to some of any of the embodiments described herein, the composition is for use in controlling a growth of a plant substrate (a crop) when applied in a vicinity of the plant substrate to thereby control (e.g., inhibit) a growth of a herb in this vicinity.

According to some of any of the embodiments described herein, the composition further comprises at least one adjuvant, for example, an adjuvant as described herein.

According to an aspect of some embodiments of the present invention there is provided a method of controlling a growth of a herb, the method comprising contacting the herb with a herbicidal effective amount of the plant extract as described herein in any of the respective embodiments and any combination thereof, or with the composition as described herein in any of the respective embodiments and any combination thereof.

According to some of any of the embodiments described herein, the herb is an Amaranthus species.

According to some of any of the embodiments described herein, the herb is selected from Amaranthus Palmeri (A. Palmeri) and Amaranthus rudis.

According to some of any of the embodiments described herein, the herb is a PS II-resistant Amaranthus rudis.

According to some of any of the embodiments described herein, the herb is a Setaria species.

According to some of any of the embodiments described herein, the herb is S. Viridis.

According to some of any of the embodiments described herein, the herb is selected from Abutilon theophrasti and Echinochloa colonum.

According to some of any of the embodiments described herein, the contacting is in an amount of from about 50 to about 10,000 g/ha, or from about 50 to about 5,000 g/ha, or from about 100 g/ha to about 5,000 g/ha, or from from about 500 g/ha to 5,000 g/ha, or from about 500 g/ha to about 4,000 g/ha, or from about 500 g/ha to about 3,000 g/ha, or from about 500 g/ha to about 2,500 g/ha, or from about 500 g/ha to about 2,000 g/ha, including any intermediate values and subranges therebetween.

According to an aspect of some embodiments of the present invention there is provided a method of controlling a growth of a plant substrate (a crop), the method comprising contacting the plant substrate or an environment thereof with the plant extract as described herein in any of the respective embodiments and any combination thereof, or the composition as described herein in any of the respective embodiments and any combination thereof, to thereby control (e.g., inhibit) a growth of a herb in the vicinity of the plant substrate, thereby controlling the growth of the plant substrate.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SPECIFIC EMBODIMENTS OF THE INVENTION

The present invention, in some embodiments thereof, relates to crop protection and, more particularly, but not exclusively, to compositions usable in promoting growth of plants by inhibiting growth of herbs and/or pests, to methods employing such compositions, and to processes of preparing such compositions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The present inventors have uncovered that Rhein and/or a glycosylated derivative thereof exhibit herbicidal activity and have sought for naturally-derived Rhein-containing herbicidal compositions. The present inventors have designed several extraction protocols, utilizing various organic solvents, optionally in combination with adjuvants, additives and/or emulsifiers, and have studied the herbicidal activity of several plant extracts obtained using these protocols.

As shown in the Examples section that follows, the present inventors have identified plant sources and respective extraction protocols that provide compositions enriched by Rhein and/or a glycosylated derivative thereof, and have demonstrated the superior herbicidal performance of such plant extracts for various weeds.

Embodiments of the present invention therefore relate to Rhein and/or a glycosylated derivative thereof-enriched plant extracts, to processes of preparing such plant extracts and to uses thereof.

### Plant Extract:

According to an aspect of some embodiments of the present invention, there is provided a plant extract which is enriched by Rhein and/or a glycosylated derivative thereof.

Herein and in the art, the phrase “plant extract” describes the product formed by an extraction process where a plant or a part thereof is used as the raw material (also referred to herein as a raw plant material or simply as a plant material). The extraction process typically includes contacting (either continuously or batch-wise or simply by mixing) the plant or the part thereof with an extraction medium, which can be optionally followed by work-up procedures such as filtration, solvent removal or replacement, addition of additives, and the like.

Prior to contacting with the extraction medium, the plant or the part thereof can be physically or chemically treated, for example, by separating a part of the plant to be subjected to extraction, grinding, pulping, and the like, and any combination thereof, to thereby provide the plant raw material.

According to some of any of the embodiments described herein, the plant extract is of (that is, is derived from) a single plant or of a part of a single plant (e.g., a single part of a single plant).

The extraction of a plant can be of the whole plant or of one or more parts thereof, for example, of a leaf, leaves, foliage, petal, roots, stems, flower and/or fruit of the plant. If a part of the plant is selected, it can be subject to extraction as is, or upon being physically or chemically treated, as described herein, to provide the raw plant material.

According to some of any of the embodiments described herein, the plant extract refers to the product of the extraction process, that is, it comprises the extraction medium used in its preparation, without removing and/or replacing the extraction medium by a different solvent or carrier.

According to some embodiments of the present invention, the extraction medium is an aqueous extraction medium, which may further comprise organic materials, as is described in further detail hereinafter. In some of these embodiments, a content of the organic material (e.g., organic solvents) ranges from about 1 to about 20, or from about 1 to about 15, or from about 1 to about 10, or from about 1 to about 5, % by volume of the total weight of the aqueous extraction medium, including any intermediate values and subranges therebetween.

According to some embodiments of the present invention there is provided a plant extract that comprises an aqueous extraction medium and at least one anthraquinone compound extracted from the plant. According to some of these embodiments, at least 50%, or at least 70%, or at least 75%, or even at least 80% of a total amount of the at least one anthraquinone consist of Rhein and/or the glycosylated derivative thereof, as described herein. Such plant extracts are also referred to herein as Rhein and/or the glycosylated derivative thereof-enriched plant extracts or simply as Rhein-enriched plant extracts.

Rhein and an exemplary glycosylated derivative thereof (Rhein glycoside) are presented in the Background Section hereinabove. Other glycosylated derivatives of Rhein include other mono-glycosylated derivatives in which the glycosyl group substitutes a different position of the anthraquinone skeleton, as well as di-, tri- or higher glycosylated derivatives, which are substituted by 2, 3, or more glycosyl moieties at different positions of the anthraquinone skeleton.

According to some of any of the embodiments described here, the plant extract exhibits a herbicidal activity, that is, is capable of controlling (e.g., inhibiting) a growth of a herb, as described in further detail hereinafter.

According to some embodiments of the present invention there is provided a plant extract that comprises Rhein and/or the glycosylated derivative thereof in an amount that is a herbicidally effective amount, that is, the obtained plant extract comprises Rhein and/or the glycosylated derivative thereof, in a concentration or amount that are sufficient to exhibit a herbicidal activity.

In exemplary, non-limiting, embodiments, a concentration of the Rhein and/or the glycosylated derivative thereof in the plant extract is at least 0.1, or of at least 0.5, mg/ml (e.g., of from 0.1 to 5, or from 0.1 to 3, mg/ml, including any intermediate values and subranges therebetween. As demonstrated in the Examples section that follows, plant extracts comprising the Rhein and/or the glycosylated derivative thereof in such a concentration exhibited a herbicidal activity.

In exemplary, non-limiting, embodiments, an amount of the Rhein and/or the glycosylated derivative thereof in the plant extract is at least 5 mg, or at least 10 mg, or at least 15 mg, per gram of the plant or the part thereof (e.g., the raw plant material), for example is from 10 to 50 mg or from 10 to 40 mg, or from 10 to 30 mg, or from 15 to 30 mg, per gram of the plant or the part thereof (e.g., the raw plant material), including any intermediate values and subranges therebetween.

In exemplary, non-limiting, embodiments, an amount of the Rhein and/or the glycosylated derivative thereof in the plant extract ranges from about 10 to about 30 mg, per gram of the plant or a part thereof (e.g., the raw plant material), including any intermediate values and subranges therebetween.

According to some of any of the embodiments described herein, the plant extract is derived from Rheum palmatum.

According to some of any of the embodiments described herein, the plant extract is obtainable from a root of Rheum palmatum, for example, from a powdered root, or a root powder prepared from Rheum palmatum, as the raw plant material. According to some of these embodiments, the root is grinded and/homogenized before being subjected to extraction.

According to some of any of the embodiments described herein, the plant extract is derived from Cassia fistula.

According to some of any of the embodiments described herein, the plant extract is obtainable from a pulp of Cassia fistula, as the raw plant material

According to some of any of the embodiments described herein, the plant extract is derived from Cassia angustifolia.

According to some of any of the embodiments described herein, the plant extract is obtainable from a leaf or leaves of Cassia angustifolia, as the raw plant material.

According to some of any of the embodiments described herein, a plant extract as described herein in generally obtainable upon contacting the plant or a part thereof with the aqueous extraction medium, optionally grinding the plant or the plant thereof before the contacting and/or optionally filtering the obtained product.

As demonstrated in the Examples section that follows, the present inventors have studied several extraction media, and have uncovered that an aqueous extraction medium that comprises an amine-containing polar organic solvent (e.g., an amine-containing alcohol) is superior to others (e.g., ethanol).

According to some of any of the embodiments described herein, the aqueous extraction medium of the plant extract comprises a polar organic solvent, preferably a protic polar organic solvent, such as an alcohol (a hydroxy-containing organic solvent which comprises one or more hydroxy groups).

According to some of any of the embodiments described herein, the organic solvent is or comprises an amine-containing compound.

As used herein, the term “amine”, which is also referred to herein as an “amine compound” or as “amine-containing compound” generally describes a compound that comprises one or more —NR′R″ group(s), wherein R′ and R″ are each independently hydrogen, alkyl, cycloalkyl, or aryl, as these terms are defined hereinbelow. The amine group can be a substituent of e.g., an alkyl, a cycloalkyl, and aryl, a heteroalicylic or a heteroaryl, as defined herein.

According to some embodiments, the amine is a primary amine, in which R′ and R″ are each hydrogen.

According to some of any of the embodiments described herein, the amine compound is an amine-containing alcohol, which further comprises one or more hydroxy groups, or an alcohol which is substituted by one or more amine groups.

In exemplary embodiment, the amine-containing compound is mono-isopropanol amine (MIPA).

In some embodiments, a concentration of the amine-containing compound as described herein, in the aqueous extraction medium, ranges from about 0.1 to about 10, or from about 1 to about 10, or from 0.1 to 5, or from 1 to 5, % by volume, of the total volume of the extraction medium, including any intermediate values and subranges therebetween. Higher concentrations, e.g., of from 10 to 20, or from 10 to 15, or from 10 to 12, % by volume, are also contemplated.

According to some of any of the embodiments described herein, the aqueous extraction medium further comprises, in addition to the amine-containing compound (e.g., an amine-containing alcohol) one or more water-soluble or water-miscible organic solvent(s).

The phrase “water-miscible organic solvent”, as used herein, refers to organic solvents that are soluble and/or dispersible in water (e.g., when mixed at room temperature at equal volumes). Several factors inherent in the structure of the solvent molecules can affect the miscibility of organic solvents in water, such as for example, the length of the carbon chain and the type of functional groups therein.

Exemplary, non-limiting, organic water-miscible solvents that are usable in the context of the present embodiments include polar and/or aprotic solvents, such as, for example, dimethyl formamide, sulfoxides such as dimethylsulfoxide, pyrrolidones, furans, ketones, pyridines, pyrimidines, etc.

According to exemplary embodiments, the organic solvent comprises a sulfoxide, for example, dimethylsulfoxide (DMSO).

According to exemplary embodiments, the organic solvent comprises a ketone, for example, acetone, methyl ethyl ketone, methyl isobutyl ketone, cyclohexanone, acetophenone, and the like. In exemplary embodiments, the organic solvent comprises acetone.

According to some exemplary embodiments, the organic solvent comprises a mixture of a ketone (e.g., acetone) and a sulfoxide (e.g., DMSO). According to some of these embodiments, a volume ratio of the ketone and the sulfoxide ranges from about 5:1 to 1:5, or from 3:1 to 1:3, or from 2:1 to 1:2, or from 5:1 to 1:1, or from 3:1 to 1:1 or from 2:1 to 1:1, including any intermediate values and subranges therebetween, and is, for example, about 2:1.

According to some of any of the embodiments described herein, a total amount of the one or more organic solvents ranges from about 1 to about 20, % by volume, of the total volume of the aqueous extraction medium, including any intermediate values and subranges therebetween.

According to some of any of the embodiments described herein, the aqueous extraction medium further comprises at least one adjuvant.

The term “adjuvant” as used herein in the context of the present embodiments, describes a substance that modifies the herbicidal activity of a composition comprising same. In some embodiments, the composition is a herbicidal composition or a composition for foliar application or for post-emergence application, as described herein, and an adjuvant in the context of these embodiments is a substance that facilitates movement of the herbicide from the leaf surface to the interior of the cell and/or improves the herbicide absorption by the plant (e.g., weed) to be treated and/or generally improves herbicidal activity.

Currently known adjuvants for post-emergence application of herbicidal compositions are typically categorized as surfactants, penetration enhancers, wetting agents, crop oil concentrates and ammonium fertilizers.

According to some embodiments of the present invention, the composition further comprises one or more adjuvants, and at least one of the adjuvant(s) is a surfactant, for example, a surfactant (also referred to herein as a “surface active agent”) known to improve herbicidal activity in post-emergence applications.

Any adjuvant or a mixture of adjuvants or any surfactant or a mixture of surfactants are usable in the context of these embodiments, including non-ionic, anionic, cationic and zwitterionic surfactants.

Representative examples of non-ionic surfactants include, without limitation, polyethoxylated alkyl phenols, polyethoxylated glyceryl esters, and polyethoxylated organic ethers derived from fatty acids, including, but not limited to, polysorbate 60, ethoxylated sorbitan stearate, ethoxylated sorbitan palmitate, ethoxylated sorbitan oleate, fatty alcohol ethoxylates, fatty acid festers, polyoxyethylene (POE) alkyl ethers, branched oxoalcohol C11 with 5 mol EO, and any combinations thereof. Additional examples of nonionic surfactants include, but are not limited to, ethoxylated castor oil, narrow-range ethoxylate, octaethylene glycol monododecyl ether, pentaethylene glycol monododecyl ether, nonoxynols, triton X-100, polyethoxylated tallow amine, cocamide monoethanolamine, cocamide diethanolamine, poloxamers, alkoxylated alcohol-phosphate esters, glycerol monostearate, glycerol monolaurate, sorbitan monolaurate, sorbitan monostearate, sorbitan tristearate, surfactants of Tween® family (e.g., Tween® 20, 40, 60, and 80), decyl glucoside, lauryl glucoside, octyl glucoside, lauryldimethylamine oxide, dimethyl sulfoxide, phosphine oxide, and others. In some embodiments, the non-ionic surfactant is an ethoxylated castor oil.

Examples of anionic surfactants include, but are not limited to, alkyl phosphate, alkyl carboxylate, alkyl sulfate, and alkyl sulfonate type surfactants, including, for example, free organic (e.g., fatty) acids, organic phosphate esters, α-olefinsulfonate and its salts, and alkali salts of sulfosuccinic acid half-esters (e.g., dioctyl ester of sodium sulfosuccinic acid).

Some exemplary anionic surfactants include, but are not limited to, Alginic acid sodium salt, ALKANOL® 189-S, Capstone® FS-66, Glycolic acid ethoxylate 4-tert-butylphenyl ether, Glycolic acid ethoxylate lauryl ether, Glycolic acid ethoxylate lauryl ether, Glycolic acid ethoxylate lauryl ether, Glycolic acid ethoxylate 4-nonylphenyl ether, Glycolic acid ethoxylate oleyl ether, Poly(ethylene glycol) 4-nonylphenyl 3-sulfopropyl ether potassium salt, Zonyl® FSA fluorosurfactant 25 wt. % Li carboxylate salt in water: isopropyl alcohol (1:1), and Zonyl® UR fluorosurfactant. Additional examples of anionic surfactants include, but are not limited to, alkylbenzenesulfonate, ammonium lauryl sulfate, sodium lauryl sulfate (sodium dodecyl sulfate, SLS, or SDS), sodium laureth sulfate (sodium lauryl ether sulfate or SLES), sodium myreth sulfate, dioctyl sodium sulfosuccinate (Docusate), perfluorooctanesulfonate (PFOS), perfluorobutanesulfonate, alkyl-aryl ether phosphates, alkyl ether phosphates, sodium stearate, sodium lauroyl sarcosinate, perfluorononanoate, and perfluorooctanoate (PFOA or PFO). In some embodiments, the anionic surfactant is a linear alkylbenzenesulfonate.

Examples of cationic surfactants include, but are not limited to, long-chained quaternized ammonium compounds, for example, behenyl trimethyl ammonium chloride, benzyl tetradecyl-dimethyl-ammonium chloride, cetyl pridinium chloride, cetyl trimethyl ammonium chloride, dimethyl dihydrogenated-tallow ammonium chloride, dimethyl stearyl ammonium chloride, dimethyl-stearyl benzyl ammonium chloride, lauryl dimethylbenzyl ammonium chloride, lauryl-trimethyl-ammonium chloride, stearyl trimethyl ammonium chloride, trimethylacetyl-ammonium bromide, and tris-(oligooxy-ethyl)alkylammonium phosphate.

Examples of zwitterionic surfactants include betaines (such as fatty acid-amidoalkylbetaine and sulfobetaine) and long-chained alkylamino acids (such as cocoaminoacetate, cocoamino-propionate, sodium cocoamphopropionate and sodium cocoamphoacetate).

According to some of any of the embodiments described herein, the surfactant is non-phytotoxic.

According to some embodiments, the composition comprises as an adjuvant at least one surfactant which is a non-ionic surfactant, for example, a polyethoxylated surfactant such as a polyethoxylated sorbitan, an ethoxylated tallow amine, tristryrilphenol ethoxylated, and like compounds.

According to some of any of the embodiments described herein, the surfactant is an anionic surfactant, for example, a fatty ether sulfate.

According to some of any of the embodiments described herein, the surfactant is polyether-modified polysiloxane. According to some of these embodiments, the composition comprises a polyether-modified polysiloxane such as marketed under the tradename Break-Thru, for example, Break-Thru® S 200, Break-Thru® S 240, Break-Thru® S 279 or Break-Thru® S 301. According to some of these embodiments, the composition comprises a polysiloxane surfactant as described herein in an amount that ranges from 0.01 to 1, or from 0.01 to 0.5, or from 0.01 to 0.1, or about 0.05, % by weight, of the total weight of the composition, including any intermediate values and subranges therebetween.

According to other embodiments of the present invention, the adjuvant is a crop oil concentrate, for example, methylated rapeseed oil such as marketed under the tradename Agnique®.

According to exemplary embodiments of the present invention, the adjuvant is or comprises fatty acid esters and/or alkoxylated alcohols-phosphate esters, such as marketed under the tradename DASH®.

According to exemplary embodiments of the present invention, the adjuvant is or comprises polyethylene glycol alkyl ethers such as, for example, polyethylene glycol monoalkyl ethers or oligoethylene glycol mono alkyl ethers marketed under the trade name Genapol®.

According to exemplary embodiments, the adjuvant comprises a mixture of fatty acid esters and/or alkoxylated alcohols-phosphate esters, such as marketed under the tradename DASH®, and polyethylene glycol alkyl ethers such as, for example, polyethylene glycol monoalkyl ethers or oligoethylene glycol mono alkyl ethers marketed under the trade name Genapol®.

According to some of any of the embodiments described herein, a total amount of the one or more adjuvants ranges from about 0.1 to about 5, or from about 1 to about 5, or from about 1 to about 3%, by volume of the total volume of the aqueous extraction medium, including any intermediate values and subranges therebetween.

The one or more adjuvants can be added to the extraction medium before, during or after contacting the plant or the part thereof with the extraction medium.

### Process:

According to an aspect of some embodiments of the present invention there is provided a process of preparing a Rhein and/or a glycosylated derivative thereof-enriched plant extract, as defined herein in any of the respective embodiments and any combination thereof.

According to some embodiments, the process is for preparing a plant extract that comprises one or more anthraquinone compounds, wherein at least 50%, or at least 70%, or at least 75% or even at least 80% of a total amount of the one or more anthraquinone compounds consist of Rhein and/or a glycosylated derivative thereof, as described herein.

According to some embodiments, the process is for preparing a plant extract that comprises Rhein and/or a glycosylated derivative thereof in an amount or concentration as described herein in any of the respective embodiments and any combination thereof.

According to some embodiments, the process is for preparing a plant extract that comprises Rhein and/or a glycosylated derivative thereof in an amount or concentration that exhibits herbicidal activity, as described herein in any of the respective embodiments and any combination thereof.

According to some of any of the embodiments described herein, the process comprises contacting a plant or a part thereof, as described herein, preferably a single plant, a part of a single plant or a single part of a single plant, as described herein, with an aqueous extraction medium.

According to some of any of the embodiments described herein, the process comprises contacting a root of Rheum palmatum (e.g., as a single plant source) with the aqueous extraction medium.

According to some of any of the embodiments described herein the aqueous extraction medium comprises one or more polar organic solvents, as described herein (e.g., one or more alcohols), and in some embodiments, the aqueous extraction medium comprises an amine-containing polar (e.g., hydroxy-containing) organic solvent, such as MIPA.

According to some of any of the embodiments described herein, the process comprises contacting a root of Rheum palmatum (e.g., as a single plant source) with the aqueous extraction medium that comprises one or more polar organic solvents, as described herein (e.g., one or more alcohols), and in some embodiments, the aqueous extraction medium comprises an amine-containing polar (e.g., hydroxy-containing) organic solvent, such as MIPA.

According to some of any of the embodiments described herein, the extraction medium further comprises at least one water-soluble or water-miscible organic solvent and/or at least one adjuvant, as described herein in any of the respective embodiments and any combination thereof. According to some of any of the embodiments described herein, there is provided a process of preparing a plant extract enriched with Rhein and/or a glycosylated derivative thereof as described herein in any of the respective embodiments and any combination thereof, for example, a plant extract in which at least 50%, or at least 70%, or at least 75%, or at least 80% of a total amount of the anthraquinone compounds therein consist of Rhein and/or a glycosylated derivative thereof, which comprises contacting a plant or a part thereof with an aqueous extraction medium, wherein the aqueous extraction medium comprises an amine-containing organic solvent as described herein, e.g., MIPA.

According to some of any of these embodiments, the aqueous organic medium further comprises at least one water-soluble or water-miscible organic solvent and/or at least one adjuvant, as described herein in any of the respective embodiments.

According to some of any of these embodiments, the contacting is with a single plant or with a part of a single part or with a single part of a single plant, as described herein.

In exemplary embodiments the single plant is Rheum palmatum.

In exemplary embodiments, the contacting is with a root of Rheum palmatum (e.g., in a form of a powder).

In exemplary embodiments, the plant is Cassia fistula.

In exemplary embodiments, the contacting is with a pulp of Cassia fistula (e.g., in a form of a powder).

In exemplary embodiments, the plant is Cassia angustifolia.

In exemplary embodiments, the contacting is with a leaf of Cassia angustifolia.

According to some of any of the embodiments described herein, the process provides a plant extract as described herein in any of the respective embodiments and any combination thereof, for example, a plant extract that exhibits herbicidal activity.

According to some of any of the embodiments described herein, there is provided a process of preparing a plant extract enriched with Rhein and/or a glycosylated derivative thereof as described herein in any of the respective embodiments and any combination thereof, for example, a plant extract in which at least 50%, or at least 70%, or at least 75%, or at least 80% of a total amount of the anthraquinone compounds therein consist of Rhein and/or a glycosylated derivative thereof, which comprises contacting a plant or a part thereof with an aqueous extraction medium, wherein the aqueous extraction medium comprises a polar organic solvent, for example, a protic polar organic solvent such as an alcohol (e.g., ethanol).

According to some of these embodiments, the process further comprises, subsequent to contacting with the extraction medium, replacing the extraction medium or a portion or part thereof (e.g., at least 40%, or at least 50%, or at least 60%, or at least 70%, or at least 80%, or about all of the extraction medium) by a different aqueous solution (e.g., removing the alcoholic organic solvent and adding to the obtained residue a different aqueous solution).

According to some of these embodiments, the extraction medium or a part or portion thereof is replaced by an aqueous solution that comprises an amine-containing organic solvent (e.g., an amine-containing alcohol) as described herein in any of the respective embodiments and any combination thereof. According to some of these embodiments, the aqueous solution further comprises at least one water-soluble or water-miscible organic solvent and/or at least one adjuvant, as described herein in any of the respective embodiments.

According to some of any of the embodiments described herein, for any of the processes described herein, the contacting is at a temperature which is about room temperature.

According to some of any of the embodiments described herein, for any of the processes described herein, the process further comprises, subsequent to the contacting, work-up procedures such as filtration, evaporation, and the like.

According to some of any of the embodiments described herein, the process further comprises, subsequent to the contacting, and before, after or during a work-up procedure, if included, adding to the obtained plant extract one or more adjuvants as described herein in any of the respective embodiments.

According to some of any of the embodiments described herein, the process further comprises, prior to contacting the plant or the part thereof with the aqueous extraction medium, grinding the plant or the part thereof.

The grinding can be effected by methods known in the art, for example, by means of metal balls, a grinding machine, etc., and/or by means of a homogenizer. The grinding is preferably utilized for providing a powder with smaller and/or more unified particles size.

The contacting of the plant with the aqueous extraction medium can be effected during a time period that ranges from minutes to hours, for example, from 5 minutes to 240 minutes, or from 5 minutes to 120 minutes, or from 5 minutes to 90 minutes, or from 5 minutes to 60 minutes, or from 30 minutes to 240 minutes, or from 30 minutes to 120 minutes, or from 30 minutes to 90 minutes, or from 30 minutes to 60 minutes, or from 60 minutes to 240 minutes, or from 60 minutes to 120 minutes, or from 60 minutes to 90 minutes, including any intermediate values and subranges therebetween. Higher time periods are also contemplated (although probably not required), for example, of up to 72 hours, or up to 48 hours, or up to 36 hours, or up to 24 hours. According to some of any of these embodiments, the contacting is at about room temperature (e.g., of from 20 to 30, or from 20 to 25, or about 25° C.).

According to embodiments of the present invention, there is provided a plant extract obtainable by any of the processes as described herein.

According to some embodiments, the obtained plant extract comprises Rhein and/or a glycosylated derivative thereof, as described herein, and the extraction medium, and optionally further comprises one or more adjuvants as described herein.

According to some embodiments, the obtained plant extract comprises Rhein and/or a glycosylated derivative thereof, as described herein, and an extraction medium that comprises at least one amine-containing polar organic solvent as described herein in any of the respective embodiments (e.g., MIPA). According to some of these embodiments, the extraction medium further comprises one or more water-miscible organic solvent(s) and/or adjuvant(s), as described herein in any of the respective embodiments. According to some of these embodiments, the obtained plant extract comprises the extraction medium and one or more water-miscible organic solvent(s) and/or adjuvant(s), as described herein in any of the respective embodiments, added to the plant extract following the contacting with the extraction medium.

According to some embodiments, the obtained plant extract comprises Rhein and/or a glycosylated derivative thereof, as described herein, and an aqueous solution that comprises an amine-containing polar organic solvent and optionally one or more adjuvants, as described herein, which are added to the plant extract upon removing the extraction medium or a part thereof.

### Composition:

According to an aspect of some embodiments of the present invention there is provided a composition that comprises a plant extract enriched with Rhein and/or a glycosylated derivative thereof, as described herein in any of the respective embodiments.

According to embodiments, the composition comprises a plant extract as described herein in any of the respective embodiments and any combination.

According to some embodiments, the composition comprises a plant extract obtained by a process as described herein in any of the respective embodiments and any combination thereof.

According to some embodiments, the composition comprises a plant extract that comprises Rhein and/or a glycosylated derivative thereof, and an aqueous solution which is the extraction medium used for obtaining the plant extract. In some of these embodiments, the composition further comprises one or more organic solvents and/or adjuvants, added to the plant extract during or subsequent to the extraction process.

According to some embodiments, the composition comprises a plant extract obtained as described herein, in which the extraction medium has been replaced by an aqueous solution that comprises an amine-containing polar organic solvent and optionally one or more organic solvent(s) and/or adjuvant(s), as described herein.

According to some of any of the embodiments described herein, the composition is for use in agricultural applications, for example, for crop protection as described in further detail hereinunder, for example, as a herbicidal composition.

According to some of any of the embodiments described herein, the composition is formulated for foliar application, and according to some of these embodiments, it is a liquid composition, which comprises a liquid carrier. According to some of any of the embodiments described herein, the composition is a form of a solution, a dispersion, a suspension, a foam, an aerosol, or an emulsion. According to some of any of the embodiments described herein, the composition is a sprayable composition.

According to some of any of the embodiments described herein, the composition further comprises an agriculturally acceptable carrier, as described and defined herein.

According to some of any of the embodiments described herein, the composition is a herbicidal composition.

According to some of any of the embodiments described herein, the composition is for use in controlling (e.g., inhibiting) a growth of a herb and/or for use in controlling a growth of a plant substrate (a crop) when applied in a vicinity of the plant substrate to thereby control (e.g., inhibit) a growth of a herb in the vicinity.

According to some of any of the embodiments described herein, the composition comprises a herbicidally effective amount of the Rhein and/or the glycosylated derivative thereof.

Any of the compositions as described herein may further comprise, in addition to the plant extract, the carrier, if present, and an adjuvant, if present, one or more additives which are typically aimed at improving the physical and/or chemical properties/consistency of the composition.

Exemplary additives include, but are not limited to, compatibility agents, buffering agents, antifoam agents, drift control agents, sticking agents (e.g., adherents, tackifiers), spreading agents, and any combination thereof.

In some embodiments, a total amount of the one or more additives in the composition can range from 0.01 to 10, for from 0.01 to 1, or from 0.01 to 0.1, or from 0.1 to 0.5, or from 0.5 to 1, or from 0.1 to 0.3, or from 0.3 to 0.5, or from 0.5 to 0.7, or from 0.7 to 1, from 1 to 2, or from 1 to 5, % by weight of the total weight of the composition, including any intermediate values and subranges therebetween.

Non-limiting examples of adherents include alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and a polyoxyethylene-polyoxybutylene block copolymer.

Non-limiting examples of suitable dispersing agents include lignin sulfite waste liquors and methylcellulose, carboxymethyl cellulose Supragil, Ufoxan, a copolymer of benzylmethacrylate, acrylic acid and 2-acrylamido-2-methyl propane sulfonic acid, and other ionic and non-ionic polymeric dispersants known in the art.

According to some embodiments of the present invention, there is provided a kit that comprises a plant extract as described herein or a composition as described herein.

According to some of these embodiments, the kit comprises a plant extract and a carrier as described herein, which are packaged together or each individually in the kit. The kit may further comprise means for applying the composition to a herb or to a vicinity of a plant substrate as described herein, for example, means for spraying the composition.

### Uses:

According to some of any of the embodiments described herein, the composition as described herein, is for use in controlling a growth of a plant substance (also referred to herein as a “plant substrate”) or in a method of controlling a growth of a plant substrate.

In some of any of the embodiments described herein, the method is for controlling herbs (weeds) and/or pests in, on or in the vicinity of a plant substrate as described herein, for example, by reducing the number of herbs and/or pests in or on soil or other plant medium and to prevent infection; by reducing the number of herbs and/or pests on plants or plant material such as roots, fruits and seeds; and/or by reducing the damaging effect of herbs and/or pests on the plant by, for example, killing, injuring or inhibiting the growth and/or activity of the herb and/or pest.

Plant pests include, for example, insects, arachnids, helminthes, nematodes, molluscs, bacteria, fungi, mites, oomycytes and protozoa. The method described herein can be used to control, kill, injure, paralyze, or reduce the activity of one or more of any of these pests in their egg, larvae, adult, juvenile, or desiccated forms.

Nematodes that damage plants include, for example, Meloidogyne spp. (root-knot), Heterodera spp., Globodera spp., Pratylenchus spp., Helicotylenchus spp., Radopholus similis, Ditylenchus dipsaci, Rotylenchulus reniformis, Xiphinema spp., Aphelenchoides spp. and Belonolaimus longicaudatus. Among the crops with the greatest estimated losses due to nematode parasitism are corn, cotton, cucurbits, leguminous vegetables, peanut, solanaceous vegetables, soybean, sugarcane, and tobacco.

Insects cause two types of damage to plants. The first type of damage is direct injury done to the plant by the insect, which eats leaves or burrows into plant tissues. There are a multitude of insect species of this type, both larvae and adults, among orthopterans, homopterans, heteropterans, coleopterans, lepidopterans, and dipterans. The second type of damage is indirect damage where the insect itself does little or no harm but transmits a bacterial, viral, or fungal infection to a plant. Insects that cause these two types of damage to plants include, for example, Coleoptera (beetles, weevils), Cerambycidae (long-horned beetles), Chrysomelidae (leaf beetles), Coccinellidae (lady beetles), Curculionidae (snout beetles, weevils, billbugs), Elateridae (click beetles), Meloidae (blister beetles), Scarabaeidae (scarab beetles), Tenebrionidae (darkling beetles), Diptera (flies), Anthomyiidae (root maggot flies), Cecidomyiidae (midges), Hemiptera suborder heteroptera (true bugs), Lygaeidae (seed bugs, chinch bugs), Miridae (plant bugs, lygus bugs), Pentatomidae (stink bugs), Hemiptera suborder homoptera (aphids, whiteflies, leafhoppers, scales), Aleyrodidae (whiteflies), Aphididae (aphids), Cercopidae (spittlebugs), Cicadellidae (leafhoppers), Membracidae (treehoppers), Lepidoptera (moths, butterflies), Noctuidae (cutworm moths), Pyralidae (snout and grass moths), Sphingidae (sphinx moths), Orthoptera (grasshoppers and crickets), Acrididae (short-horned grasshoppers), Gryllidae (crickets), Gryllotalpidae (mole crickets), Thysanoptera (thrips), Thripidae (common thrips), Acarina (mites), Tetranychidae (spider mites).

Arachnids such as earth mites (Penthaleidae), thread-footed mites (Tarsonemidae) and gall and rust mites (Eriophyoidea) can also cause damage to plants.

Molluscs, including those in the gastropod class and those in the subclass pulmonata, can cause damage to plants. Molluscs also include, for example, snails and slugs, such as Ampullariidae spp.; Arion spp. (A. ater, A. circumscriptus, A. hortensis, A. rufus); Bradybaenidae spp. (Bradybaena fruticum); Cepaea spp. (C. hortensis, C. nemoralis); Ochlodina; Deroceras spp. (D. agrestis, D. empiricorum, D. laeve, D. reticulatum); Discus spp. (D. rotundatus); Euomphalia spp.; Galba spp. (G. trunculata); Helicelia spp. (H. itala, H. obvia); Helicidae spp. (Helicigona arbustorum); Helicodiscus spp.; Helix spp. (H. aperta); Limax spp. (L. cinereoniger, L. flavus, L. marginatus, L. maximus, L. tenellus); Lymnaea spp.; Milax spp. (M. gagates, M. marginatus, M. sowerbyi); Opeas spp.; Pomacea spp. (P. canaticulata); Vallonia spp, and Zanitoides.

Herbs known to damage plants include, for example, Lolium rigidum, Amaramthus palmeri, Abutilon theopratsi, Sorghum halepense, Conyza Canadensis, Setaria verticillata, Capsella pastoris, and Cyperus rotundus. Additional herbs include, for example, Mimosa pigra, salvinia, hyptis, senna, noogoora, burr, Jatropha gossypifolia, Parkinsonia aculeate, Chromolaena odorata, Cryptoslegia grandiflora, Anndropogon gayanus. Additional herbs are described hereinbelow.

According to some of any of the embodiments described herein, controlling the growth of the plant is effected by contacting the plant substrate or its vicinity with a composition as described herein.

According to some of any of the embodiments described herein, when controlling the growth of the plant substrate is by killing, injuring or inhibiting the growth and/or activity of an undesired herb in the vicinity of the plant, the method is effected by contacting the herb with the composition as described herein.

According to some of any of the embodiments described herein, the contacting is effected by applying the composition to a plant's foliage or to a herb's foliage (foliar application).

In some of any of the embodiments described herein, the composition is applied to a plant's or herb's leaf or leaves.

In some of any of the embodiments described herein, contacting the plant substrate or a vicinity thereof with a composition as described herein comprises spraying the composition onto the plant's or herb's foliage (e.g., herb's leaf or leaves).

Spraying the composition onto a plant substrate or herb can be effected, for example, by means of a hand-held container (e.g., bottle-shaped) equipped with a spray nozzle, and filled with the composition. The device can be equipped with a hand-operated trigger or valve, which, when operated, dispenses the composition through the spray nozzle. Alternatively or additionally, the device can include means for connecting the spray nozzle to a pressure source (e.g., a fluid source, such as, but not limited to, a source of pressurized water or air), such that the composition is dispensed from the container through the spray nozzle by means of the pressure applied by the pressure source.

Alternatively, spraying can be effected by passing the composition through the spray nozzle by means of a pump. Devices as described herein, which further comprise such a pump are therefore also contemplated. Wheeled machines having means for dispensing the composition through one or more spray nozzles, as a result of a pressure supplied by a pump, and also usable in the context of these embodiments.

Distribution of the composition can also be effected by means of a propeller, optionally connected to a pump.

Also contemplated are systems deployed for distributing the composition on relatively large areas (e.g., at least 100 square meters). Such a system can comprise a controller, a distribution system and a communication channel or network establishing communication between the controller and the distribution system. The controller optionally and preferably includes an electronic circuit configured for operating the distribution system. The system can also comprise a data processor which can be configured to vary the time intervals employed by the controller based on a predetermined criterion or set of criteria.

The distribution system can be, for example, a liquid distribution system such as, but not limited to, a sprinkler system, a center-pivot irrigation system, a drip irrigation system, a mist sprayer system, and the like.

In some of any of the embodiments described herein, contacting the plant substrate with a composition as described herein comprises contacting a plant's root with the composition. Such contacting can be effected by hydroponic irrigation, by adding the composition to the aqueous solution used for hydroponic irrigation. Alternatively, the composition is applies to the soil surrounding the plant's root, by introducing the composition to an irrigation system or by integrating the composition with an irrigation system.

According to some embodiments, an agronomic field in need of plant control is treated by application of the composition directly to the surface of the growing plants, such as by a spray. For example, the method is applied to control weeds in a field of crop plants by spraying the field with the composition. The composition can be provided as a tank mix, a sequential treatment of components, or a simultaneous treatment or mixing of one or more of the components of the composition from separate containers. Treatment of the field can occur as often as needed to provide weed control and the components of the composition can be adjusted to target specific weed species or weed families through utilization of specific compositions capable of selectively targeting the specific species or plant family to be controlled.

According to some of any of the embodiments described herein, the composition as described herein is a herbicidal composition which is for inhibiting growth of a herb (e.g., weed) in the vicinity of the plant substrate.

Weeds, or weedy plants, are plants that compete with cultivated plants.

Exemplary weeds that are treatable by a composition as described herein include, but are not limited to, weeds of the Amaranthus species such as A. albus, A. blitoides, A. hybridus, A. palmeri, A. powellii, A. retroflexus, A. spinosus, A. tuberculatus, and A. viridis; weeds of the Ambrosia species such as A. trifida, A. artemisifolia; weeds of the Lolium species such as L. multiflorum, L. rigidium, L perenne; weeds of the Digitaria species such as D. insularis; weeds of the Euphorbia species such as E. heterophylla; weeds of the Kochia species such as K. scoparia; weeds of the Sorghum species such as S. halepense; weeds of the Conyza species such as C. bonariensis, C. canadensis, C. sumatrensis; weeds of the Chloris species such as C. truncate; weeds of the Echinochloa species such as E. colona, E. crus-galli; weeds of the Eleusine species such as E. indica; weeds of the Poa species such as P. annua; weeds of the Plantago species such as P. lanceolata; weeds of the Avena species such as A. fatua; weeds of the Chenopodium species such as C. album; weeds of the Setaria species such as S. viridis, Abutilon theophrasti; weeds of the Ipomoea species; weeds of Sesbania species; weeds of the Cassia species; weeds of the Sida species; weeds of the Brachiaria species; and weeds of the Solanum species.

Additional weedy plant species found in cultivated areas include Alopecurus myosuroides, Avena sterilis, Avena sterilis ludoviciana, Brachiaria plantaginea, Bromus diandrus, Bromus rigidus, Cynosurus echinatus, Digitaria ciliaris, Digitaria ischaemum, Digitaria sanguinalis, Echinochloa oryzicola, Echinochloa phyllopogon, Eriochloa punctata, Hordeum glaucum, Hordeum leporinum, Ischaemum rugosum, Leptochloa chinensis, Lolium persicum, Phalaris minor, Phalaris paradoxa, Rottboellia exalta, Setaria faberi, Setaria viridis var, robusta-alba schreiber, Setaria viridis var, robusta-purpurea, Snowdenia polystachea, Sorghum sudanese, Alisma plantago-aquatica, Amaranthus lividus, Amaranthus quitensis, Ammania auriculata, Ammania coccinea, Anthemis cotula, Apera spica-venti, Bacopa rotundifolia, Bidens pilosa, Bidens subalternans, Brassica tournefortii, Bromus tectorum, Camelina microcarpa, Chrysanthemum coronarium, Cuscuta campestris, Cyperus difformis, Damasonium minus, Descurainia sophia, Diplotaxis tenuifolia, Echium plantagineum, Elatine triandra var, pedicellata, Euphorbia heterophylla, Fallopia convolvulus, Fimbristylis miliacea, Galeopsis tetrahit, Galium spurium, Helianthus annuus, Iva xanthifolia, Ixophorus unisetus, Ipomoea indica, Ipomoea purpurea, Ipomoea sepiaria, Ipomoea aquatic, Ipomoea triloba, Lactuca serriola, Limnocharis flava, Limnophila erecta, Limnophila sessiliflora, Lindernia dubia, Lindernia dubia var major, Lindernia micrantha, Lindernia procumbens, Mesembryanthemum crystallinum, Monochoria korsakowii, Monochoria vaginalis, Neslia paniculata, Papaver rhoeas, Parthenium hysterophorus, Pentzia suffruticosa, Phalaris minor, Raphanus raphanistrum, Raphanus sativus, Rapistrum rugosum, Rotala indica var, uliginosa, Sagittaria guyanensis, Sagittaria montevidensis, Sagittaria pygmaea, Salsola iberica, Scirpus juncoides var ohwianus, Scirpus mucronatus, Setaria lutescens, Sida spinosa, Sinapis arvensis, Sisymbrium orientale, Sisymbrium thellungii, Solanum ptycanthum, Sonchus aspen, Sonchus oleraceus, Sorghum bicolor, Stellaria media, Thlaspi arvense, Xanthium strumarium, Arctotheca calendula, Conyza sumatrensis, Crassocephalum crepidiodes, Cuphea carthagenenis, Epilobium adenocaulon, Erigeron philadelphicus, Landoltia punctata, Lepidium virginicum, Monochoria korsakowii, Solanum americanum, Solanum nigrum, Vulpia bromoides, Youngia japonica, Hydrilla verticillata, Carduus nutans, Carduus pycnocephalus, Centaurea solstitialis, Cirsium arvense, Commelina diffusa, Convolvulus arvensis, Daucus carota, Digitaria ischaemum, Echinochloa crus-pavonis, Fimbristylis miliacea, Galeopsis tetrahit, Galium spurium, Limnophila erecta, Matricaria perforate, Papaver rhoeas, Ranunculus acris, Soliva sessilis, Sphenoclea zeylanica, Stellaria media, Nassella trichotoma, Stipa neesiana, Agrostis stolonifera, Polygonum aviculare, Alopecurus japonicus, Beckmannia syzigachne, Bromus tectorum, Chloris inflate, Echinochloa erecta, Portulaca oleracea, and Senecio vulgaris.

According to some embodiments of the invention, the weeds include monocotyledonous (monocot) weeds and dicotyledonous (dicot) weeds.

Non-limiting examples of Dicotyledon weed species include Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Emex, Datura, Viola, Galeopsis, Papaver, Trifolium, Abutilon, and Centaurea.

Non-limiting examples of Monocotyledon weed species include Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbris tylis, Sagittaria, Eleocharis, Scirpus, Paspalum, Ischaenum, Sphenoclea, Dactyloctenium, Agrostis, Alopecurus and Apera.

According to some of any of the embodiments described herein, the weed is an Amaranthus species, for example, Amaranthus palmeri (A. Palmeri) and/or Amaranthus rudis.

According to some of any of the embodiments described herein, the weed is Echinochloa colonum.

According to some of any of the embodiments described herein, the weed is Abutilon theophrasti.

According to some of any of the embodiments described herein, the weed is Solanum nigrum.

According to some of any of the embodiments described herein, the weed is a Setaria species.

According to some of any of the embodiments described herein, the weed is S. viridis.

According to some of any of the embodiments described herein, the weed or herb is a resistant herb, which is resistant to common herbicides, as exemplified in the Examples section that follows.

Crop plants in which weed control is needed include, but are not limited to, i) corn, soybean, cotton, canola, sugar beet, alfalfa, sugarcane, rice, and wheat; ii) vegetable plants including, but not limited to, tomato, sweet pepper, hot pepper, melon, watermelon, cucumber, eggplant, cauliflower, broccoli, lettuce, spinach, onion, peas, carrots, sweet corn, Chinese cabbage, leek, fennel, pumpkin, squash or gourd, radish, Brussels sprouts, tomatillo, garden beans, dry beans, or okra; iii) culinary plants including, but not limited to, basil, parsley, coffee, or tea; iv) fruit plants including, but not limited to, apple, pear, cherry, peach, plum, apricot, banana, plantain, table grape, wine grape, citrus, avocado, mango, or berry; v) a tree grown for ornamental or commercial use, including, but not limited to, a fruit or nut tree; or vi) an ornamental plant (e.g., an ornamental flowering plant or shrub or turf grass). The methods and compositions provided herein can also be applied to plants produced by a cutting, cloning, or grafting process (i.e., a plant not grown from a seed) including fruit trees and plants that include, but are not limited to, citrus, apples, avocados, tomatoes, eggplant, cucumber, melons, watermelons, and grapes, as well as various ornamental plants.

According to some of any of the embodiments described herein, the composition of the present embodiments is for controlling a growth of a pest as described herein in or in the vicinity of a plant substrate as described herein. According to these embodiments, a composition as described herein is a pesticidal composition.

In some embodiments, the herbicidal and/or pesticidal composition as described herein is applied to a plant or to an area under cultivation for accomplishing a total vegetative control. In some embodiments, the herbicidal composition is applied to a plant substrate or to the area under cultivation for accomplishing a complete eradication of a weed as described herein.

As used herein, the term “area under cultivation” is intended to include fields, hard landscapes such as driveways, paths, patios, roads, pavements, railways and the like, as well as soil, or established vegetation. Herein, the phrase “plant substrate” encompasses a cultivated plant.

In some embodiments, the herbicidal and/or pesticidal composition is applied, depending on the concentration, for controlling weeds in perennial cultures such as: decorative tree plantings, fruit orchards, vineyards, citrus groves, nut orchards, banana plantations, coffee plantations, tea plantations, rubber plantations, oil palm plantations, cocoa plantations, soft fruit plantings and hop fields, and for the selective combating of weeds in annual cultures.

In some of any of the embodiments described herein, the herbicidal and/or pesticidal composition is applied as a pre-emergent application or as a post-emergent application.

In some embodiments, contacting the plant substrate or the herb or weed with the herbicidal composition is in an amount that ranges between 0.5 grams per hectare (g/ha) and 3000 g/ha, or between 5 g/ha and 2500 g/ha, or between 5 g/ha and 2000 g/ha, or between 50 g/ha and 2500 g/ha, or between 50 grams per hectare (g/ha) and 2000 g/ha, or between 50 g/ha and 1500 g/ha, or between 100 g/ha and 3000 g/ha, or between 100 g/ha and 2500 g/ha, or between 100 grams per hectare (g/ha) and 2000 g/ha, or between 100 g/ha and 1000 g/ha, or between 100 g/ha and 500 g/ha, including any intermediate values and subranges therebetween.

In some embodiments, contacting the plant substrate or the herb or weed with the herbicidal composition is in an amount that ranges from 50 to 10000 g/ha, or from 50 to 5000 g/ha, or from 100 g/ha to 5000 g/ha, or from 500 g/ha to 5000 g/ha, or from 500 g/ha to 4000 g/ha, or from 500 g/ha to 3000 g/ha, or from 500 g/ha to 2500 g/ha, or from 500 g/ha to 2000 g/ha, including any intermediate subranges and values therebetween.

Any of the compositions and uses as described herein can utilize one or more additional herbicides in combination with the plant extract as described herein. Such herbicides can be incorporated in the composition or co-applied to the plant substrate as described herein with the composition.

According to some embodiments, a combination of the plant extract as described herein with an additional herbicide can provide for a synergistic effect, and/or can be used to treat herbs that are resistant to the additional herbicide, and/or can broaden the spectrum of herbs that are treatable by the additional herbicide.

Exemplary herbicides include, but are not limited to, amide herbicides, aromatic acid herbicides, arsenical herbicides, benzothiazole herbicides, benzoylcyclohexanedione herbicides, benzofuranyl alkylsulfonate herbicides, carbamate herbicides, cyclohexene oxime herbicides, cyclopropylisoxazole herbicides, herbicides, dicarboximide dinitroaniline herbicides, dinitrophenol herbicides, diphenyl ether herbicides, dithiocarbamate herbicides, halogenated aliphatic herbicides, imidazolinone herbicides, inorganic herbicides, nitrile herbicides, organophosphorus herbicides, oxadiazolone herbicides, oxazole herbicides, phenoxy herbicides, phenylenediamine herbicides, pyrazole herbicides, pyridazine herbicides, pyridazinone herbicides, pyridine herbicides, pyrimidinediamine herbicides, pyrimidinyloxybenzylamine herbicides, quaternary ammonium herbicides, thiocarbamate herbicides, thiocarbonate herbicides, thiourea herbicides, triazine herbicides, triazinone herbicides, triazole herbicides, triazolone herbicides, triazolopyrimidine herbicides, uracil herbicides, and urea herbicides.

Representative herbicides of these families include but are not limited to acetochlor, acifluorfen, acifluorfen-sodium, aclonifen, acrolein, alachlor, alloxydim, allyl alcohol, ametryn, amicarbazone, amidosulfuron, aminopyralid, amitrole, ammonium sulfamate, anilofos, asulam, atraton, atrazine, azimsulfuron, BCPC, beflubutamid, benazolin, benfluralin, benfuresate, bensulfuron, bensulfuron-methyl, bensulide, bentazone, benzfendizone, benzobicyclon, benzofenap, bifenox, bilanafos, bispyribac, bispyribac-sodium, borax, bromacil, bromobutide, bromoxynil, butachlor, butafenacil, butamifos, butralin, butroxydim, butylate, cacodylic acid, calcium chlorate, cafenstrole, carbetamide, carfentrazone, carfentrazone-ethyl, CDEA, CEPC, chlorflurenol, chlorflurenol-methyl, chloridazon, chlorimuron, chlorimuron-ethyl, chloroacetic acid, chlorotoluron, chlorpropham, chlorsulfuron, chlorthal, chlorthal-dimethyl, cinidon-ethyl, cinmethylin, cinosulfuron, cisanilide, clethodim, clodinafop, clodinafop-propargyl, clomazone, clomeprop, clopyralid, cloransulam, cloransulam-methyl, CMA, 4-CPB, CPMF, 4-CPP, CPPC, cresol, cumyluron, cyanamide, cyanazine, cycloate, cyclosulfamuron, cycloxydim, cyhalofop, cyhalofop-butyl, 2,4-D, 3,4-DA, daimuron, dalapon, dazomet, 2,4-DB, 3,4-DB, 2,4-DEB, desmedipham, dicamba, dichlobenil, ortho-dichlorobenzene, para-dichlorobenzene, dichlorprop, dichlorprop-P, diclofop, diclofop-methyl, diclosulam, difenzoquat, difenzoquat metilsulfate, diflufenican, diflufenzopyr, dimefuron, dimepiperate, dimethachlor, dimethametryn, dimethenamid, dimethenamid-P, dimethipin, dimethylarsinic acid, dinitramine, dinoterb, diphenamid, diquat, diquat dibromide, dithiopyr, diuron, DNOC, 3,4-DP, DSMA, EBEP, endothal, EPTC, esprocarb, ethalfluralin, ethametsulfuron, ethametsulfuron-methyl, ethofumesate, ethoxyfen, ethoxysulfuron, etobenzanid, fenoxaprop-P, fenoxaprop-P-ethyl, fentrazamide, ferrous sulfate, flamprop-M, flazasulfuron, florasulam, fluazifop, fluazifop-butyl, fluazifop-P, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, fluoroglycofen, fluoroglycofen-ethyl, flupropanate, flupyrsulfuron, flupyrsulfuron-methyl-sodium, flurenol, fluridone, fluorochloridone, fluoroxypyr, flurtamone, fluthiacet, fluthiacet-methyl, fomesafen, foramsulfuron, fosamine, glufosinate, glufosinate-ammonium, glyphosate, halosulfuron, halosulfuron-methyl, haloxyfop, haloxyfop-P, HC-252, hexazinone, imazamethabenz, imazamethabenz-methyl, imazamox, imazapic, imazapyr, imazaquin, imazethapyr, imazosulfuron, indanofan, iodomethane, iodosulfuron, iodosulfuron-methyl-sodium, ioxynil, isoproturon, isouron, isoxaben, isoxachlortole, isoxaflutole, karbutilate, lactofen, lenacil, linuron, MAA, MAMA, MCPA, MCPA-thioethyl, MCPB, mecoprop, mecoprop-P, mefenacet, mefluidide, mesosulfuron, mesosulfuron-methyl, mesotrione, metam, metamifop, metamitron, metazachlor, methabenzthiazuron, methylarsonic acid, methyldymron, methyl isothiocyanate, metobenzuron, metolachlor, S-metolachlor, metosulam, metoxuron, metribuzin, metsulfuron, metsulfuron-methyl, MK-66, molinate, monolinuron, MSMA, naproanilide, napropamide, naptalam, neburon, nicosulfuron, nonanoic acid, norflurazon, oleic acid (fatty acids), orbencarb, orthosulfamuron, oryzalin, oxadiargyl, oxadiazon, oxasulfuron, oxaziclomefone, oxyfluorfen, paraquat, paraquat dichloride, pebulate, pendimethalin, penoxsulam, pentachlorophenol, pentanochlor, pentoxazone, pethoxamid, petrolium oils, phenmedipham, phenmedipham-ethyl, picloram, picolinafen, pinoxaden, piperophos, potassium arsenite, potassium azide, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium, propyzamide, prosulfocarb, prosulfuron, pyraclonil, pyraflufen, pyraflufen-ethyl, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium, quinclorac, quinmerac, quinoclamine, quizalofop, quizalofop-P, rimsulfuron, sethoxydim, siduron, simazine, simetryn, SMA, sodium arsenite, sodium azide, sodium chlorate, sulcotrione, sulfentrazone, sulfometuron, sulfometuron-methyl, sulfosate, sulfosulfuron, sulfuric acid, tar oils, 2,3,6-TBA, TCA, TCA-sodium, tebuthiuron, tepraloxydim, terbacil, terbumeton, terbuthylazine, terbutryn, thenylchlor, thiazopyr, thifensulfuron, thifensulfuron-methyl, thiobencarb, tiocarbazil, topramezone, tralkoxydim, tri-allate, triasulfuron, triaziflam, tribenuron, tribenuron-methyl, tricamba, triclopyr, trietazine, trifloxysulfuron, trifloxysulfuron-sodium, trifluralin, triflusulfuron, triflusulfuron-methyl, trihydroxytriazine, tritosulfuron, [3-[2-chloro-4-fluoro-5-(methyl-6-trifluoromethyl-2,4-dioxo-2,3,4-tetrahy-dropyrimidin-3-yl) phenoxy]-2-pyridyloxy]acetic acid ethyl ester (CAS RN 353292-3-6), 4-[(4,5-dihydro-3-methoxy-4-methyl-5-oxo)-H—,2,4-triazolylcarbonyl-sulfam-oyl]-5-methylthiophene-3-carboxylic acid (BAY636), BAY747 (CAS RN 33504-84-2), topramezone (CAS RN 2063-68-8), 4-hydroxy-3-[2-[(2-methoxyethoxy)methyl]-6-(trifluoro-methyl)-3-pyridiny-1]carbonyl]-bicyclo[3.2.]oct-3-en-2-one (CAS RN 35200-68-5), and 4-hydroxy-3-[[2-(3-methoxypropyl)-6-(difluoromethyl)-3-pyridinyl]carbonyl-]-bicyclo[3.2.]oct-3-en-2-one.

According to some embodiments of the present invention, a pesticidal composition as described herein further includes, or be used in combination with various agricultural chemicals and/or insecticides, miticides and fungicides, pesticidal and biopesticidal agents. Examples include but are not limited to azinphos-methyl, acephate, isoxathion, isofenphos, ethion, etrimfos, oxydemeton-methyl, oxydeprofos, quinalphos, chlorpyrifos, chlorpyrifos-methyl, chlorfenvinphos, cyanophos, dioxabenzofos, dichlorvos, disulfoton, dimethylvinphos, dimethoate, sulprofos, diazinon, thiometon, tetrachlorvinphos, temephos, tebupirimfos, terbufos, naled, vamidothion, pyraclofos, pyridafenthion, pirimiphos-methyl, fenitrothion, fenthion, phenthoate, flupyrazophos, prothiofos, propaphos, profenofos, phoxime, phosalone, phosmet, formothion, phorate, malathion, mecarbam, mesulfenfos, methamidophos, methidathion, parathion, methyl parathion, monocrotophos, trichlorphon, EPN, isazophos, isamidofos, cadusafos, diamidaphos, dichlofenthion, thionazin, fenamiphos, fosthiazate, fosthietan, phosphocarb, DSP, ethoprophos, alanycarb, aldicarb, isoprocarb, ethiofencarb, carbaryl, carbosulfan, xylylcarb, thiodicarb, pirimicarb, fenobucarb, furathiocarb, propoxur, bendiocarb, benfuracarb, methomyl, metolcarb, XMC, carbofuran, aldoxycarb, oxamyl, acrinathrin, allethrin, esfenvalerate, empenthrin, cycloprothrin, cyhalothrin, gamma-cyhalothrin, lambda-cyhalothrin, cyfluthrin, beta-cyfluthrin, cypermethrin, alpha-cypermethrin, zeta-cypermethrin, silafluofen, tetramethrin, tefluthrin, deltamethrin, tralomethrin, bifenthrin, phenothrin, fenvalerate, fenpropathrin, furamethrin, prallethrin, flucythrinate, fluvalinate, flubrocythrinate, permethrin, resmethrin, ethofenprox, cartap, thiocyclam, bensultap, acetamiprid, imidacloprid, clothianidin, dinotefuran, thiacloprid, thiamethoxam, nitenpyram, chlorfluazuron, diflubenzuron, teflubenzuron, triflumuron, novaluron, noviflumuron, bistrifluoron, fluazuron, flucycloxuron, flufenoxuron, hexaflumuron, lufenuron, chromafenozide, tebufenozide, halofenozide, methoxyfenozide, diofenolan, cyromazine, pyriproxyfen, buprofezin, methoprene, hydroprene, kinoprene, triazamate, endosulfan, chlorfenson, chlorobenzilate, dicofol, bromopropylate, acetoprole, fipronil, ethiprole, pyrethrin, rotenone, nicotine sulphate, BT (Bacillus Thuringiensis) agent, spinosad, abamectin, acequinocyl, amidoflumet, amitraz, etoxazole, chinomethionat, clofentezine, fenbutatin oxide, dienochlor, cyhexatin, spirodiclofen, spiromesifen, tetradifon, tebufenpyrad, binapacryl, bifenazate, pyridaben, pyrimidifen, fenazaquin, fenothiocarb, fenpyroximate, fluacrypyrim, fluazinam, flufenzin, hexythiazox, propargite, benzomate, polynactin complex, milbemectin, lufenuron, mecarbam, methiocarb, mevinphos, halfenprox, azadirachtin, diafenthiuron, indoxacarb, emamectin benzoate, potassium oleate, sodium oleate, chlorfenapyr, tolfenpyrad, pymetrozine, fenoxycarb, hydramethylnon, hydroxy propyl starch, pyridalyl, flufenerim, flubendiamide, flonicamid, metaflumizole, lepimectin, TPIC, albendazole, oxibendazole, oxfendazole, trichlamide, fensulfothion, fenbendazole, levamisole hydrochloride, morantel tartrate, dazomet, metam-sodium, triadimefon, hexaconazole, propiconazole, ipconazole, prochloraz, triflumizole, tebuconazole, epoxiconazole, difenoconazole, flusilazole, triadimenol, cyproconazole, metconazole, fluquinconazole, bitertanol, tetraconazole, triticonazole, flutriafol, penconazole, diniconazole, fenbuconazole, bromuconazole, imibenconazole, simeconazole, myclobutanil, hymexazole, imazalil, furametpyr, thifluzamide, etridiazole, oxpoconazole, oxpoconazole fumarate, pefurazoate, prothioconazole, pyrifenox, fenarimol, nuarimol, bupirimate, mepanipyrim, cyprodinil, pyrimethanil, metalaxyl, mefenoxam, oxadixyl, benalaxyl, thiophanate, thiophanate-methyl, benomyl, carbendazim, fuberidazole, thiabendazole, manzeb, propineb, zineb, metiram, maneb, ziram, thiuram, chlorothalonil, ethaboxam, oxycarboxin, carboxin, flutolanil, silthiofam, mepronil, dimethomorph, fenpropidin, fenpropimorph, spiroxamine, tridemorph, dodemorph, flumorph, azoxystrobin, kresoxim-methyl, metominostrobin, orysastrobin, fluoxastrobin, trifloxystrobin, dimoxystrobin, pyraclostrobin, picoxystrobin, iprodione, procymidone, vinclozolin, chlozolinate, flusulfamide, dazomet, methyl isothiocyanate, chloropicrin, methasulfocarb, hydroxyisoxazole, potassium hydroxyisoxazole, echlomezol, D-D, carbam, basic copper chloride, basic copper sulfate, copper nonylphenolsulfonate, oxine copper, DBEDC, anhydrous copper sulfate, copper sulfate pentahydrate, cupric hydroxide, inorganic sulfur, wettable sulfur, lime sulfur, zinc sulfate, fentin, sodium hydrogen carbonate, potassium hydrogen carbonate, sodium hypochlorite, silver, edifenphos, tolclofos-methyl, fosetyl, iprobenfos, dinocap, pyrazophos, carpropamid, fthalide, tricyclazole, pyroquilon, diclocymet, fenoxanil, kasugamycin, validamycin, polyoxins, blasticiden S, oxytetracycline, mildiomycin, streptomycin, rape seed oil, machine oil, benthiavalicarbisopropyl, iprovalicarb, propamocarb, diethofencarb, fluoroimide, fludioxanil, fenpiclonil, quinoxyfen, oxolinic acid, chlorothalonil, captan, folpet, probenazole, acibenzolar-S-methyl, tiadinil, cyflufenamid, fenhexamid, diflumetorim, metrafenone, picobenzamide, proquinazid, famoxadone, cyazofamid, fenamidone, zoxamide, boscalid, cymoxanil, dithianon, fluazinam, dichlofluanide, triforine, isoprothiolane, ferimzone, diclomezine, tecloftalam, pencycuron, chinomethionat, iminoctadine acetate, iminoctadine albesilate, ambam, polycarbamate, thiadiazine, chloroneb, nickel dimethyldithiocarbamate, guazatine, dodecylguanidine-acetate, quintozene, tolylfluanid, anilazine, nitrothalisopropyl, fenitropan, dimethirimol, benthiazole, harpin protein, flumetover, mandipropamide and penthiopyrad.

In any of the compositions and uses as described herein, the plant extract can be used in combination with additional one or more anthraquinone compounds (other than Rhein and/or a glycosylated derivative thereof) as described herein, preferably anthraquinone compounds that exhibit herbicidal activity. The additional anthraquinone compounds can be a part of the plant extract and/or as an additional herbicide added to the composition or used in combination with the composition.

As used herein throughout, an anthraquinone compound is a compound represented by Formula I:

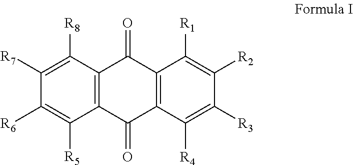

wherein each of R₁-R₈ can independently be a substituent as described herein, for example, an alkyl, a cycloalkyl, hydroxy, alkoxy, amine, hydroxyalkyl, aminoalkyl, carboxy and/or a saccharide.

In exemplary embodiments, one or more of R₁-R₈ is hydroxy and/or alkoxy and/or carboxy.

In exemplary embodiments, R₁ and R₈ are each independently selected from hydrogen, OR₉, —C(═O)—OR₁₀, and amine, wherein R₉ and R₁₀ are each independently selected from hydrogen, a saccharide, —C(═O)—R₁₁, and alkyl, and R₁₁ is hydrogen or alkyl.

In exemplary embodiments, R₂ is selected from hydrogen, OR₉, and —C(═O)—OR₁₀;

In exemplary embodiments, R₃ is selected from hydrogen, OR₉, —C(═O)—OR₁₀, and hydroxyalkyl;

In exemplary embodiments, R₄ is selected from hydrogen, OR₉ and amine;

In exemplary embodiments, R₅ and R₇ are each hydrogen;

In exemplary embodiments, R₆ is selected from hydrogen and alkyl;

In exemplary embodiments, R₉ is selected from hydrogen, a saccharide, and —C(═O)—R₁₁;

In exemplary embodiments, R₁₀ is selected from hydrogen and alkyl.

Exemplary anthraquinones include, but are not limited to, emodin, aloe emodin, parietin (physcion), emodin glycoside, physcion glycoside, chrysophanol and chrysophanol glycoside.

Any of the compounds described herein can be in a form of an agriculturally acceptable salt thereof.

The phrase “agriculturally acceptable salt” refers to a charged species of the parent compound and its counter ion, which is typically used to modify the solubility characteristics of the parent compound and/or to reduce any significant adverse effect to an agricultural substrate by the parent compound, while not abrogating the biological activity and properties of the administered compound.

In the context of some of the present embodiments, an agriculturally acceptable salt of the compounds described herein may optionally be a base addition salt comprising at least one acidic (e.g., carboxylic acid) group of the compound which is in a negatively charged form (e.g., wherein the acidic group is deprotonated), in combination with at least one counter-ion, derived from the selected base, that forms an agriculturally acceptable salt.

The base addition salts of the compounds described herein may therefore be complexes formed between one or more acidic groups of the drug and one or more equivalents of a base.

The base addition salts may include a variety of organic and inorganic counter-ions and bases, such as, but not limited to, sodium (e.g., by addition of NaOH), potassium (e.g., by addition of KOH), calcium (e.g., by addition of Ca(OH)₂, magnesium (e.g., by addition of Mg(OH)₂), aluminum (e.g., by addition of Al(OH)₃ and ammonium (e.g., by addition of ammonia). Each of these acid addition salts can be either a mono-addition salt or a poly-addition salt, as these terms are defined herein.

In the context of some of the present embodiments, an agriculturally acceptable salt of the compounds described herein may optionally be an acid addition salt comprising at least one base group (e.g., amine group) of the compound which is in a positively charged form (e.g., wherein an amine group is protonated), in combination with at least one counter-ion, derived from the selected acid, that forms an agriculturally acceptable salt.

The acid addition salts of the compounds described herein may therefore be complexes formed between one or more basic groups of the drug and one or more equivalents of an acid.

The acid addition salts may include a variety of organic and inorganic acids, such as, but not limited to, hydrochloric acid which affords a hydrochloric acid addition salt, hydrobromic acid which affords a hydrobromic acid addition salt, acetic acid which affords an acetic acid addition salt, ascorbic acid which affords an ascorbic acid addition salt, benzenesulfonic acid which affords a besylate addition salt, camphorsulfonic acid which affords a camphorsulfonic acid addition salt, citric acid which affords a citric acid addition salt, maleic acid which affords a maleic acid addition salt, malic acid which affords a malic acid addition salt, methanesulfonic acid which affords a methanesulfonic acid (mesylate) addition salt, naphthalenesulfonic acid which affords a naphthalenesulfonic acid addition salt, oxalic acid which affords an oxalic acid addition salt, phosphoric acid which affords a phosphoric acid addition salt, toluenesulfonic acid which affords a p-toluenesulfonic acid addition salt, succinic acid which affords a succinic acid addition salt, sulfuric acid which affords a sulfuric acid addition salt, tartaric acid which affords a tartaric acid addition salt and trifluoroacetic acid which affords a trifluoroacetic acid addition salt. Each of these acid addition salts can be either a mono-addition salt or a poly-addition salt, as these terms are defined herein.

Depending on the stoichiometric proportions between the charged group(s) in the compound and the counter-ion in the salt, the acid or base additions salts can be either mono-addition salts or poly-addition salts.

The phrase “mono-addition salt”, as used herein, refers to a salt in which the stoichiometric ratio between the counter-ion and charged form of the compound is 1:1, such that the addition salt includes one molar equivalent of the counter-ion per one molar equivalent of the compound.

The phrase “poly-addition salt”, as used herein, refers to a salt in which the stoichiometric ratio between the counter-ion and the charged form of the compound is greater than 1:1 and is, for example, 2:1, 3:1, 4:1 and so on, such that the addition salt includes two or more molar equivalents of the counter-ion per one molar equivalent of the compound.

The present invention further encompasses prodrugs, solvates and hydrates of the substances described herein.

As used herein, the term “prodrug” refers to an agent, which is converted into the active compound (the active parent drug) upon application to the target substrate. Prodrugs are typically useful for facilitating the storage and/or application of the parent compound. They may, for instance, be more bioavailable whereas the parent compound is not. The prodrug may also have improved solubility and/or stability as compared with the parent compound in agricultural compositions (e.g., pesticidal or herbicidal formulations). Prodrugs are also often used to achieve a sustained release of the active compound. A prodrug may comprise, for example, the active compound modified with ester groups, for example, wherein any one or more of the hydroxyl groups of a compound is modified by an acyl group, optionally (C₁₋₄) acyl (e.g., acetyl) group to form an ester group, and/or any one or more of the carboxylic acid groups of the compound is modified by an alkoxy or aryloxy group, optionally (C₁₋₄)alkoxy (e.g., methyl, ethyl) group to form an ester group.

The term “solvate” refers to a complex of variable stoichiometry (e.g., di-, tri-, tetra-, penta-, hexa-, and so on), which is formed by a solute (the compound as described herein) and a solvent, whereby the solvent does not interfere with the activity of the solute. Suitable solvents include, for example, ethanol, acetic acid and the like.

The term “hydrate” refers to a solvate, as defined hereinabove, where the solvent is water.

The compounds described herein can be used as polymorphs and the present embodiments further encompass any isomorph of the compounds and any combination thereof.

The present embodiments further encompass any enantiomers and diastereomers of the compounds described herein.

As used herein, the term “enantiomer” refers to a stereoisomer of a compound that is superposable with respect to its counterpart only by a complete inversion/reflection (mirror image) of each other. Enantiomers are said to have “handedness” since they refer to each other like the right and left hand. Enantiomers have identical chemical and physical properties except when present in an environment which by itself has handedness, such as all living systems. In the context of the present embodiments, a compound may exhibit one or more chiral centers, each of which exhibiting an R- or an S-configuration and any combination, and compounds according to some embodiments of the present invention, can have any their chiral centers exhibit an R- or an S-configuration.

The term “diastereomers”, as used herein, refers to stereoisomers that are not enantiomers to one another. Diastereomerism occurs when two or more stereoisomers of a compound have different configurations at one or more, but not all of the equivalent (related) stereocenters and are not mirror images of each other. When two diastereoisomers differ from each other at only one stereocenter they are epimers. Each stereo-center (chiral center) gives rise to two different configurations and thus to two different stereoisomers. In the context of the present invention, embodiments of the present invention encompass compounds with multiple chiral centers that occur in any combination of stereo-configuration, namely any diastereomer.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

The term “treating” refers to inhibiting, preventing or arresting the development of a pathology (disease, disorder or condition) and/or causing the reduction, remission, or regression of a pathology. Those of skill in the art will understand that various methodologies and assays can be used to assess the development of a pathology, and similarly, various methodologies and assays may be used to assess the reduction, remission or regression of a pathology.

As used herein, the term “preventing” refers to keeping a disease, disorder or condition from occurring in a plant substrate (e.g., a crop) who may be at risk for the disease, but has not yet been diagnosed as having the disease.

The term “alkyl” describes a saturated aliphatic hydrocarbon including straight chain and branched chain groups. Preferably, the alkyl group has 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. More preferably, the alkyl is a medium size alkyl having 2 to 10 carbon atoms. Most preferably, unless otherwise indicated, the alkyl is a lower alkyl having 2 to 6 carbon atoms. The alkyl group may be substituted or unsubstituted, as defined herein.

The term “cycloalkyl” or “alicyclic” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted.

The term “heteroalicyclic” describes a monocyclic or fused ring group having in the ring(s) one or more atoms such as nitrogen, oxygen and sulfur. The rings may also have one or more double bonds. However, the rings do not have a completely conjugated pi-electron system. The heteroalicyclic may be substituted or unsubstituted. Representative examples are piperidine, piperazine, tetrahydrofurane, tetrahydropyrane, morpholino and the like.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted.

Whenever an alkyl, cycloalkyl, heteroalicyclic, aryl, heteroaryl or a hydrocarbon is substituted by one or more substituents, each substituent group can independently be, for example, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, C-carboxylate, O-carboxylate, N-thiocarbamate, O-thiocarbamate, urea, thiourea, N-carbamate, O-carbamate, C-amide, N-amide, guanyl, guanidine and hydrazine.

A “hydroxy” group refers to an —OH group.

An “azide” group refers to a —N═N+═N⁻ group.

An “alkoxy” group refers to both an —O-alkyl and an —O-cycloalkyl group, as defined herein.

An “aryloxy” group refers to both an —O-aryl and an —O-heteroaryl group, as defined herein.

A “thiohydroxy” or “thiol” group refers to a —SH group.

A “thioalkoxy” group refers to both an —S-alkyl group, and an —S-cycloalkyl group, as defined herein.

A “thioaryloxy” group refers to both an —S-aryl and an —S-heteroaryl group, as defined herein.

A “carbonyl” group refers to a —C(═O)—R′ group, where R′ is defined as hereinabove. An acetyl is a carbonyl, as defined herein, wherein R′ is a substituted or unsubstituted methyl.

A “thiocarbonyl” group refers to a —C(═S)—R′ group, where R′ is as defined herein.

A “C-carboxy” group refers to a —C(═O)—O—R′ groups, where R′ is as defined herein.

An “O-carboxy” group refers to an R′C(═O)—O— group, where R′ is as defined herein.

An “oxo” group refers to a ═O group.

A “carboxylate” or “carboxyl” encompasses both C-carboxy and O-carboxy groups, as defined herein.

A “carboxylic acid” group refers to a C-carboxy group in which R′ is hydrogen.

A “thiocarboxy” or “thiocarboxylate” group refers to both —C(═S)—O—R′ and —O—C(═S) R′ groups.

An “ester” refers to a C-carboxy group wherein R′ is not hydrogen.

An ester bond refers to a —O—C(═O)— bond.

A “halo” group refers to fluorine, chlorine, bromine or iodine.

A “sulfinyl” group refers to an —S(═O)—R′ group, where R′ is as defined herein.

A “sulfonyl” group refers to an —S(═O)₂—R′ group, where R′ is as defined herein.

A “sulfonate” group refers to an —S(═O)₂—O—R′ group, where R′ is as defined herein.

A “sulfate” group refers to an —O—S(═O)₂—O—R′ group, where R′ is as defined as herein.

A “sulfonamide” or “sulfonamido” group encompasses both S-sulfonamido and N-sulfonamido groups, as defined herein.

An “S-sulfonamido” group refers to a —S(═O)₂—NR′R″ group, with each of R′ and R″ as defined herein.

An “N-sulfonamido” group refers to an R'S(═O)₂—NR″ group, where each of R′ and R″ is as defined herein.

An “O-carbamyl” group refers to an —OC(═O)—NR′R″ group, where each of R′ and R″ is as defined herein.

An “N-carbamyl” group refers to an R′OC(═O)—NR″— group, where each of R′ and R″ is as defined herein.

A “carbamyl” or “carbamate” group encompasses O-carbamyl and N-carbamyl groups.

A carbamate bond describes a —O—C(—O)—NR′— bond, where R′ is as described herein.

An “O-thiocarbamyl” group refers to an —OC(═S)—NR′R″ group, where each of R′ and R″ is as defined herein.

An “N-thiocarbamyl” group refers to an R′OC(═S) NR″— group, where each of R′ and R″ is as defined herein.

A “thiocarbamyl” or “thiocarbamate” group encompasses O-thiocarbamyl and N-thiocarbamyl groups.

A thiocarbamate bond describes a —O—C(═S)—NR′— bond, where R′ is as described herein.

A “C-amido” group refers to a —C(═O)—NR′R″ group, where each of R′ and R″ is as defined herein.

An “N-amido” group refers to an R′C(═O)—NR″— group, where each of R′ and R″ is as defined herein.

An “amide” group encompasses both C-amido and N-amido groups.

An amide bond describes a —NR′—C(═O)— bond, where R′ is as defined herein.

A “urea” group refers to an —N(R′)—C(═O)—NR″R′″ group, where each of R′ and R″ is as defined herein, and R′″ is defined as R′ and R″ are defined herein.

A “nitro” group refers to an —NO₂ group.

A “cyano” group refers to a —C≡N group.

The term “phosphonyl” or “phosphonate” describes a —P(═O)(OR′)(OR″) group, with R′ and R″ as defined hereinabove.

The term “phosphate” describes an —O—P(═O)(OR′)(OR″) group, with each of R′ and R″ as defined hereinabove.

A “phosphoric acid” is a phosphate group is which each of R is hydrogen.

The term “phosphinyl” describes a —PR′R″ group, with each of R′ and R″ as defined hereinabove.

The term “thiourea” describes a —N(R′)—C(═S)—NR″— group, with each of R′ and R″ as defined hereinabove.

As used herein, the term “amine” describes both a —NR′R″ group, wherein R′ and R″ are each independently hydrogen, alkyl, cycloalkyl, aryl, as these terms are defined hereinbelow.

The amine group can therefore be a primary amine, where both R′ and R″ are hydrogen, a secondary amine, where R′ is hydrogen and R″ is alkyl, cycloalkyl or aryl, or a tertiary amine, where each of R′ and R″ is independently alkyl, cycloalkyl or aryl.

Alternatively, R′ and R″ can each independently be hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine, as defined herein.

Herein throughout, R, R′ and R″ are each independently hydrogen, alkyl, cycloalkyl, or aryl, as these terms are defined herein, and can alternatively be each independently hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, O-thiocarbamate, urea, thiourea, N-carbamate, O-carbamate, C-amide, N-amide, guanyl, guanidine and hydrazine, as these terms are defined herein.

As used herein, the term “alkylene glycol” describes a —O—[(CR′R″)_{z}—O]_{y}—R′″ end group or a —O—[(CR′R″)_{z}—O]_{y}-linking group, with R′, R″ and R′″ being as defined herein, and with z being an integer of from 1 to 10, preferably, from 2 to 6, more preferably 2 or 3, and y being an integer of 1 or more. Preferably R′ and R″ are both hydrogen. When z is 2 and y is 1, this group is ethylene glycol. When z is 3 and y is 1, this group is propylene glycol. When y is 2-4, the alkylene glycol is referred to herein as oligo (alkylene glycol). Any of the compounds (e.g., active agents, compound of Formula I) described herein can be in a form of a pharmaceutically acceptable salt thereof.

The term “saccharide” as used herein encompasses monosaccharides, disaccharides and oligosaccharides. The term “monosaccharide”, as used herein and is well known in the art, refers to a simple form of a sugar that consists of a single saccharide molecule which cannot be further decomposed by hydrolysis. Most common examples of monosaccharides include glucose (dextrose), fructose, galactose, and ribose. Monosaccharides can be classified according to the number of carbon atoms of the carbohydrate, i.e., triose, having 3 carbon atoms such as glyceraldehyde and dihydroxyacetone; tetrose, having 4 carbon atoms such as erythrose, threose and erythrulose; pentose, having 5 carbon atoms such as arabinose, lyxose, ribose, xylose, ribulose and xylulose; hexose, having 6 carbon atoms such as allose, altrose, galactose, glucose, gulose, idose, mannose, talose, fructose, psicose, sorbose and tagatose; heptose, having 7 carbon atoms such as mannoheptulose, sedoheptulose; octose, having 8 carbon atoms such as 2-keto-3-deoxy-manno-octonate; nonose, having 9 carbon atoms such as sialose; and decose, having 10 carbon atoms. Monosaccharides are the building blocks of oligosaccharides like sucrose (common sugar).

In exemplary embodiments, the saccharide is a glycoside.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Mono-isopropanol amine (MIPA) was obtained from Merck (Sigma-Aldrich® 471291).

Dash® HC (referred to herein as DASH) was obtained from BASF. It is a non-ionic surfactant composed of fatty acid esters and alkoxylated alcohols-phosphate esters, at a ratio of about 1.67:1.

Genapol® X-080 iso-tridecyl alcohol polyglycol ether (8EO), also known as polyethylene glycol monoalkyl ether or oligoethylene glycol mono alkyl ether (referred to herein as Genapol) was obtained from Merck (Sigma-Aldrich® 48750).

Ethanol, acetone and dimethyl sulfoxide (DMSO) were obtained from known vendors unless otherwise mentioned.

Rheum palmatum root powder was obtained from Starwest Botanicals or from TheTreeOfLoveShop, Cassia fistula pulp powder and Cassia angustifolia leaves powder were obtained from Bixa Botanical.

Weeds of the species Amaranthus palmeri, Amaranthus rudis, Setaria viridis, Abutilon theophrasti, Solanum nigrum, Echinochloa colonum, and Lolium multiflorum are all from Agrematch seed collection.

Spraying of the weeds with the tested extract samples was performed using a VL-SET Paasche Airbrush.

Filtration was performed using a Hario V60 paper filter size 200±22 μm.

Damage assessment: Herbicidal activity was assessed and scored by visual inspection of the plants in comparison to plants treated with the formulation alone (with no plant extract) as control. Activity score is in the range of 0 to 100, where 0 represents no herbicidal activity like control plants and 100 represents the maximal herbicidal activity (i.e., total death of the plant).

High Performance Liquid Chromatography: HPLC was performed on a Thermo Scientific™ Dionex™ UltiMate 3000 instrument, using Phenomenex, Gemini C18 150×4.6 mm, 3 μm column; column temperature: 40° C.; Flow rate: 1 ml/minute; UV Detection: 420 nm; Mobile phase A: 0.1% Formic acid in water v/v; Mobile phase B: Acetonitrile; Injection volume: 5 μl; Gradient was performed as described herein Table A1:

TABLE A1

| | Solution A (0.1% | Solution B |
|---|---|---|
| Time (min) | formic acid; %) | (acetonitrile; %) |
| 0.0 | 85 | 15 |
| 2.0 | 85 | 15 |
| 6.0 | 60 | 40 |
| 8.0 | 40 | 60 |
| 16.5 | 20 | 80 |
| 17.0 | 5 | 95 |
| 20.0 | 5 | 95 |
| 20.1 | 85 | 15 |
| 25.0 | 85 | 15 |

Table A2 below presents the retention times of identified exemplary anthraquinones at the above-described HPLC conditions.

TABLE A2

| Retention time (min) | compound |
|---|---|
| 7.050 | Rhein glycoside |
| 10.927 | Emodin |
| 12.420 | Aloe-emodin |
| 13.123 | Chrysophanol |
| 15.390 | Rhein |

### Example 1

### Extraction Protocols

The present inventors have conceived using Rhein and/or derivatives thereof (e.g., Rhein-glycoside) as a herbicide and, in a search for plant extract-based herbicides, have studied the herbicidal activity of powders extracted from different Rhein-containing plants and from different plant organs thereof, using different extraction protocols, as follows:
Plant source A: Rheum palmatum (Rhubarb) root powder.
Plant source C: Cassia fistula pulp powder.
Plant source D: Cassia angustifolia leaves powder.

Each plant source, A, C and D, was subjected to different extraction protocols in order to obtain a Rhein-containing extract samples. Three main extraction protocols were tested, identified herein as Protocol 1, Protocol 2 and Protocol 3, and each of these protocols was practiced using different extraction solutions (identified herein as a, b, c, and so forth), containing different organic solvents and/or different combinations of organic solvents and additives, adjuvants and/or emulsifiers.

Herein throughout, “% vol.” relates to a volume percentage of the total solution volume.

### Protocol 1:

### Extraction Protocols 1a, 1b, 1c and 1d:

(i) 1 gram of Plant source A, C, or D powder was mixed and vortexed with one of the following solutions:
1a. 10 ml aqueous solution of 2% vol. MIPA; or
1b. 10-20 ml aqueous solution of 2% vol. MIPA, 2% vol. DASH and 0.25% vol. Genapol; or
1c. 10-20 ml aqueous solution of 10% vol. Acetone, 5% vol. DMSO, 2% vol. MIPA, 2% vol. DASH and 0.25% vol. Genapol; or
1d. 10 ml aqueous solution of 8% vol. MIPA;
(ii) The resulting solution was then filtered through Hario V60 paper filter to obtain approximately 5-10 ml of a clear solution.
An exemplary such protocol is embodied in the following Extraction protocol, referred to herein as 1a4:

### Exemplary Extraction Protocol to Obtain Extraction Samples A-1a4 and A-1a′:

(i) 5 grams of Rheum palmatum root powder were mixed and vortexed with 50 ml aqueous solution containing 2% vol. MIPA.
(ii) The solution was thereafter filtered through Hario V60 paper filter to obtain Extraction sample A-1a4. A sample from the filtrate was analyzed by HPLC (see, hereinbelow).
(iii) The filtrate obtained in step (ii) above was mixed with DASH and Genapol at a final concentration of 2% vol, and 0.25% vol., respectively, to thereby obtain Extract sample A-1a′ (see, Example 2 hereinbelow).

### Protocol 2:

### Extraction Protocol 2a:

(i) 10 grams of Plant source (A, C or D) powder were mixed with 70% ethanol in water (100 ml).
(ii) The solution was shaken at 240 rpm for 5-7 days at room temperature.
(iii) The solution was filtered through Hario V60 paper filter.
(iv) The solution was heated in a water bath at 70-90° C. until evaporation completed, to obtain a brown sticky gel-like extract at the bottom of the beaker.
(v) An aqueous solution containing 2% vol MIPA (100-150 ml) was added to the beaker and stirred until complete dissolution.
Exemplary such protocol is embodied in the following Extraction protocol, which is referred to herein as 2a6:
   Exemplary Extraction protocol to obtain extraction sample A-2a6:
(i) 10 grams of Rheum palmatum root powder were mixed with 70% ethanol in water (100 ml).
(ii) The solution was shaken at 240 rpm for 6 days at room temperature.
(iii) The solution was filtered through Hario V60 paper filter.
(iv) The solution was heated in a water bath at 70-90° C. until complete evaporation to obtain a brown sticky gel-like extract at the bottom of the beaker.
(v) An aqueous solution containing 2% vol MIPA (100 ml) were added to the beaker and stirred until completely dissolution, to obtain Extraction sample A-2a6. A sample from the filtrate was analyzed by HPLC (see, hereinbelow).

### Extraction Protocol 2b:

Following step (v) of Extraction protocol 2a, DASH and Genapol were added at a final concentration of 2% vol, and 0.25% vol., respectively.

### Exemplary Extraction Protocol to Obtain Extraction Sample A-2b′:

(i) 10 grams of Rheum palmatum root powder were mixed with 70% ethanol in water (100 ml).
(ii) The solution was shaken at 240 rpm for 6 days at room temperature.
(iii) The solution was filtered through Hario V60 paper filter.
(iv) The solution was heated in a water bath at 70-90° C. until complete evaporation to obtain a brown sticky gel-like extract at the bottom of the beaker.
(v) An aqueous solution containing 2% vol MIPA (100 ml) were added to the beaker and stirred until completely dissolution, to obtain Extraction sample A-2a6.
(vi) The filtrate was mixed with DASH and Genapol at a final concentration of 2% vol and 0.25% vol., respectively, to thereby obtain Extract sample A-2b′ (see, Example 2 hereinbelow).

### Protocol 3:

### Extraction Protocol 3a:

(i) 10 grams of Plant source A (Rheum palmatum root) powder were mixed with 70% ethanol in water (100 ml).
(ii) The solution was shaken at 240 rpm for 2 days at room temperature.
(iii) The solution was filtered through Hario V60 paper filter.
(iv) The solution was heated in a water bath at 70-90° C. until evaporation completed, to obtain a brown sticky gel-like extract at the bottom of the beaker.
(v) An aqueous solution containing 2% vol MIPA (100 ml) was added to the beaker and stirred until complete dissolution.
Extraction protocol 3b: Following step (v) of Extraction protocol 3a, DASH and Genapol were added at a final concentration of 2% vol, and 0.25% vol., respectively.

Exemplary extract samples from Plant source A, A-1a4 and A-2a6, were analyzed by HPLC, as described hereinabove, and the results are presented in Table 1 below.

TABLE 1

| | | Extract | Extract |
|---|---|---|---|
| | | sample A-1a4 | sample A-2a6 |
| Compound | Chemical Structure | Concentration [mg/ml] | |
| Rhein | 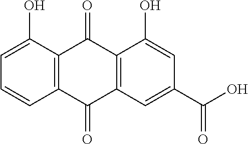 [SMILES: O=C(O)c1cc(O)c2c(c1)C(=O)c1cccc(O)c1C2=O] | 1.39 | 0.80 |
| Emodin | 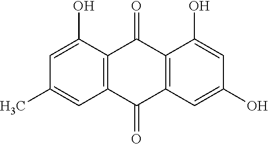 [SMILES: Cc1cc(O)c2c(c1)C(=O)c1cc(O)cc(O)c1C2=O] | 0.10 | 0.05 |
| Aloe-emodin | 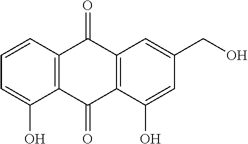 [SMILES: O=C1c2cccc(O)c2C(=O)c2c(O)cc(CO)cc21] | 0.04 | 0.05 |
| Chrysophanol | 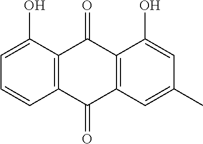 [SMILES: Cc1cc(O)c2c(c1)C(=O)c1cccc(O)c1C2=O] | 0.15 | 0.18 |
| Rhein-glycoside | 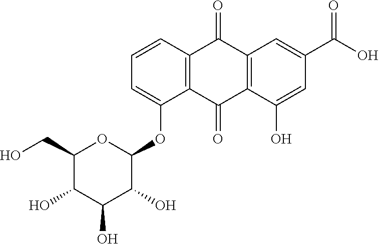 [SMILES: O=C(O)c1cc(O)c2c(c1)C(=O)c1cccc(O[C@@H]3O[C@H](CO)[C@@H](O)[C@H](O)[C@H]3O)c1C2=O] | 0.67 | 0.12 |

As can be seen in Table 1, Rhein and/or Rhein glycoside are the most abundant anthraquinone derivatives in both tested Extract samples, consisting together more than 75% by weight of the identified anthraquinones.

Significantly higher concentration of Rhein and Rhein glycoside was observed in the exemplary Extract sample A-1a4 in comparison to Extract sample A-2a6, which indicates that extraction method 1a from plant source A (Rheum palmatum) was more efficient than extraction method 2a from the same source, at least in terms of the Rhein and Rhein glycoside content. These data suggest that extracting Rhein and Rhein-based derivatives from plant source A is more efficient using Protocol 1, which employs an aqueous solution of MIPA as the extraction medium, than using Protocol 2, which employs ethanol as the extraction medium.

### Example 2

### Post-Emergence Studies

The herbicidal activity of each of the obtained Rhein-containing extract samples (from the tested plants Rheum palmatum, Cassia fistula, and Cassia angustifolia; as described in Example 1 hereinabove) were determined by post-emergence assays, as described in further detail hereinbelow.

The herbicidal activity of Rhein-containing extracts was determined by post-emergence application on 8-day old plants (weeds) of the Amaranthus palmeri and Setaria viridis species that were grown at 16 hours/8 hours day/night cycles at 30° C./25° C., respectively. Leaf stage was typically 4-6 for A. palmeri and 3-4 for S. viridis.

In each treatment, one 100 cm² pot containing about 6 Amaranthus palmeri or Setaria viridis plants, was sprayed with 1 ml of the respective Rhein-containing extract sample.

Herbicidal activity was assessed and scored 4 days after application by visual inspection of the plants in comparison to plants treated with the control solution alone (with no active ingredient). Activity score is in the range of 0 to 100, where 0 represents no herbicidal activity like control plants and 100 represents the maximal herbicidal activity (i.e., total death of the plant).

The scores are presented in Table 2 below.

TABLE 2

| | | | | A. | S. |
|---|---|---|---|---|---|
| Extract | Plant | Extraction | | palmeri | viridis |
| sample | source | protocol | Control aqueous solution | score | score |
| A-1b | A | 1b | 2% MIPA, 2% DASH and 0.25% Genapol | 95 | 100 |
| A-1a′* | A | 1a′ * | 2% MIPA, 2% DASH and 0.25% Genapol | 95 | N/A |
| A-1c | A | 1c | 10% Acetone, 5% DMSO, 2% MIPA, 2% | 100 | 95 |
| | | | DASH, 0.25% Genapol | | |
| C-1b | C | 1b | 2% MIPA, 2% DASH and 0.25% Genapol | 0 | 0 |
| C-1c | C | 1c | 10% Acetone, 5% DMSO, 2% MIPA, 2% | 0 | 0 |
| | | | DASH, 0.25% Genapol | | |
| D-1b | D | 1b | 2% MIPA, 2% DASH and 0.25% Genapol | 60 | 0 |
| D-1c | D | 1c | 10% Acetone, 5% DMSO, 2% MIPA, 2% | 50 | 0 |
| | | | DASH, 0.25% Genapol | | |
| A-2a6 | A | 2a | 2% MIPA | 0 | 0 |
| A-2b′** | A | 2b | 2% MIPA, 2% DASH and 0.25% Genapol | 100 | 65 |
| C-2b | C | 2b | 2% MIPA, 2% DASH and 0.25% Genapol | 40 | 10 |
| D-2b | D | 2b | 2% MIPA, 2% DASH and 0.25% Genapol | 95 | 0 |

*Extract sample A-1a4 was mixed with DASH and Genapol to get 2% vol and 0.25% vol, respectively, to obtain Extract sample A-1a′.
**Extract sample A-2a6 was mixed with DASH and Genapol to get 2% vol and 0.25% vol, respectively, to obtain Extract sample A-2b′ (in accordance with Extraction protocol 2b).

As can be seen in Table 2, extracts from Plant source A (Rheum palmatum root powder) provided the highest herbicidal activity against both weed species Amaranthus palmeri and Setaria viridis.

Comparison between Extract samples A-1a′ and A-1b in Table 2 indicates that extraction with MIPA alone followed by addition of DASH and Genapol provided the same herbicidal activity as inclusion of DASH and Genapol in the extraction process, therefore implies that the presence of DASH and Genapol is not required in the extraction process.

The data presented in Table 2 also indicates that extraction protocol 1, using a MIPA-containing extraction medium, is generally superior to extraction protocols that use ethanol-containing extraction medium, and that this effect is more pronounced for Plant source A.

The data presented in Table 2 also indicates that extraction method 2b (i.e., addition of adjuvants such as DASH and Genapol) generally improves the overall herbicidal activity scores in comparison with extraction method 2a. These data show the advantageous effect of the tested adjuvants on the herbicidal activity of the extract composition.

Extract sample A-1c demonstrated high potency while extract sample D-1c provided lower activity scores. These data demonstrate that extracts obtained using protocol 1c and plant source A (Rheum palmatum) are advantageous over plant source D (Cassia angustifolia).

Overall, these data suggest that a combination of MIPA, DASH and Genapol, optionally along with acetone and DMSO, either as the extraction medium or following extraction with ethanol, is superior to other protocols.

### Weed Panel:

In order to assess the herbicidal activity of the Rhein-containing extract sample A-1b on a variety of weeds, a post-emergence weed panel experiment was performed.

Herbicidal activity of extract sample A-1b was determined by post-emergence application on 8-day old plants (weeds) of the A. palmeri and S. viridis species and 11-day old plants (weeds) of Abutilon theophrasti, Solanum nigrum, Echinochloa colonum, Phalaris canarinesis and Lolium multiflorum that were grown at 16 hours/8 hours day/night cycles at 30° C./25° C., respectively. Leaf stage was typically 4-6 for A. palmeri, 3-4 for S. viridis, 3 for A. theophrasti and S. nigrum, 4 for E. colonum, and 2 for P. canarinesis and L. multiflorum.

In each treatment, one 100 cm² pot containing about 6 plants of each tested weed species, was sprayed with 1 ml of the exemplary extract sample A-1b. Herbicidal activity was assessed and scored 3 days after application, as described hereinabove. Activity scores are the average of two repeats and are presented in Table 3 below.

TABLE 3

| Weed (specie) | Score |
|---|---|
| Amaranthus palmeri | 97.5 |
| Setaria viridis | 85 |
| Solanum nigrum | 55 |
| Lolium multiflorum | 15 |

Table 3 shows that herbicidal activity was observed for all tested weed species, with the highest activity demonstrated against A. palmeri and S. viridis.

In order to assess the herbicidal activity of the Rhein-containing extract sample A-1b on a variety of weeds, and to compare its activity to a chemically-synthesized Rhein (also referred to herein as “synthetic Rhein”), a post-emergence weed panel experiment was performed.

Herbicidal activity was determined by post-emergence application on 7-day old plants (weeds) of the A. palmeri and S. viridis species and 8-day old plants (weeds) of S. nigrum, and C. quinoa that were grown at 16 hours/8 hours day/night cycles at 30° C./25° C., respectively. Leaf stage was typically 4-6 for A. palmeri, 3-4 for S. viridis, and 4 for S. nigrum and C. quinoa.

Each treatment contained five 80 cm² pots, each containing about 4 plants of one of the tested weed species. Each pot was sprayed with 0.8 ml of either:
1. the exemplary extract sample A-1b, in which plant source A powder was mixed with solution 1b for 1.5 hours before filtration, or
2. 1 gram/liter synthetic Rhein molecule dissolved in 2% MIPA, 2% DASH and 0.25% Genapol solution, which is equivalent to 1000 g/ha.

Herbicidal activity was assessed and scored 13 days after application, as described hereinabove. Activity scores are the average of five repeats (5 pots) and are presented in Table 4 below.

TABLE 4

| | A-1b extract | Synthetic Rhein |
|---|---|---|
| Weed (specie) | Score | Score |
| Amaranthus palmeri | 100 | 100 |
| Setaria viridis | 92 | 97 |
| Solanum nigrum | 99 | 100 |
| Chenopodium quinoa | 96 | 100 |

Table 4 shows that herbicidal activity of the Rhein-enriched plant extract and the synthetic Rhein-containing formulation was equivalent.

The herbicidal activity of Rhein-containing extraction samples from protocols 1b, 2b and 3b, as well as the stability of Extract samples A-2b, were assessed on weeds in post-emergence experiments.

Extracts from Plant source A were prepared with protocols 1, 2 and 3 using 2% MIPA, 2% DASH, 0.25% Genapol solution (A-1b, A-2b and A-3b, respectively). Each extract was diluted 2-fold or 4-fold using 2% MIPA, 2% DASH, 0.25% Genapol solution. Herbicidal activity of the extracts was determined by post-emergence application on 8-day old plants (weeds) of the A. palmeri and S. viridis species that were grown at 16 hours/8 hours day/night cycles at 30° C./25° C., respectively. Leaf stage was typically 4-6 for A. palmeri and 3-4 for S. viridis.

In each treatment, one 100 cm² pot containing about 6 A. palmeri or S. viridis plants, with 1 ml of the respective Rhein-containing extract sample. Herbicidal activity was assessed and scored 4 days after application, as described herein. The activity scores are presented in Table 5 below.

TABLE 5

| | Extraction | Dilution | A. palmeri | S. viridis |
|---|---|---|---|---|
| Extract sample | protocol | factor | Score | Score |
| A-1b | 1b | 1 | 100 | 65 |
| A-1b | 1b | 2 | 100 | 80 |
| A-3b | 3b | 1 | 100 | 40 |
| A-3b | 3b | 2 | 90 | 30 |
| A-2b (A9#1)* | 2b | 2 | 100 | 95 |
| A-2b (A9#1)* | 2b | 4 | 80 | 75 |
| A-2b (A9#2)** | 2b | 2 | 100 | 90 |
| A-2b (A9#2)** | 2b | 4 | 70 | 65 |

*Prepared 40 days before application and was stored in room temperature in dark conditions.
**Prepared on the day of application.

The data presented in Table 5 demonstrate comparable herbicidal activity for the tested extract samples, with no substantial change in the herbicidal activity upon storage.

The herbicidal activity of Rhein-containing extraction samples from protocols 1b and 1d, with mixing duration of step (i) ranging between 15 minutes to 24 hours were assessed on A. palmeri weeds in a post-emergence experiment.

Extracts from Plant source A were prepared according to protocol 1 using either 2% MIPA, 2% DASH, 0.25% Genapol solution (A-1b) or 8% MIPA solution (A-1d). Mixing duration were either 15 minutes, 1.5 hour or 24 hours. A-1b extract was then diluted 4-fold using 2% MIPA, 2% DASH, 0.25% Genapol solution and A-1d extract was diluted 4-fold using 2.67% DASH, 0.33% Genapol solution to obtain final extract solution of 2% MIPA, 2% DASH, and 0.25% Genapol. Herbicidal activity of the extracts was determined by post-emergence application on 8-day old plants (weeds) of the A. palmeri specie that was grown at 16 hours/8 hours day/night cycles at 30° C./25° C., respectively.

Each treatment contained three 100 cm² pots. Each pot contained about 6 A. palmeri plants and was sprayed with 1 ml of the respective Rhein-containing extract sample. Herbicidal activity was assessed and scored 6 days after application, as described herein. Average activity scores are presented in Table 6 below.

TABLE 6

| Extract | Extraction | Dilution | Mixing | | A. palmeri |
|---|---|---|---|---|---|
| sample | protocol | factor | duration | | Score |
| A-1b | 1b | 4 | 15 | minutes | 62 |
| A-1b | 1b | 4 | 1.5 | hour | 72 |
| A-1b | 1b | 4 | 24 | hours | 68 |
| A-1d | 1d | 4 | 15 | minutes | 60 |
| A-1d | 1d | 4 | 1.5 | hours | 73 |

The data presented in Table 6 demonstrate an increase in herbicidal activity when mixing duration is increased from 15 minutes to 1.5 hour, but shows no additional increase in herbicidal activity when mixing duration is further increased to 24 hours. Moreover, no significant difference in herbicidal activity was observed between extraction protocol 1b and 1d.

While further studying the extraction sample, it was observed that source A powder supplied by different vendors had different grinding levels, such that powders obtained from certain vendors contained more coarse particles than from other vendors.

In order to test the effect of grinding level of source A on the extract herbicidal activity, different grinding methos were employed. Grinding was performed by either contacting the powder with metal beads or by using Homogenizer, as follows.

Extracts from Plant source A were prepared with protocol 1b. After mixing the powder with solution 1b, stainless steel beads were added to the vial and the solution was vortexed for 5 minutes. Alternatively, after addition of solution 1b, it was homogenized for 3 minutes using T 10 Basic Ultra-Turrax with S 10 N-8 G Dispersing tool. Both solutions were then mixed for 1.5 hour before the final filtration step. Extracts were then diluted 4-fold using 2% MIPA, 2% DASH, and 0.25% Genapol solution. As a reference protocol, extraction with no metal beads or homogenization was performed. Herbicidal activity of the extracts was determined by post-emergence application on 8-day old plants (weeds) of the A. palmeri specie that was grown at 16 hours/8 hours day/night cycles at 30° C./25° C., respectively.

Each treatment contained three 100 cm² pots. Each pot contained about 6 A. palmeri plants and each was sprayed with 1 ml of the respective Rhein-containing extract sample. Herbicidal activity was assessed and scored 6 days after application, as described herein. Average activity scores are presented in Table 7 below.

TABLE 7

| Extract | Extraction | Dilution | Mixing | Grinding | A. palmeri |
|---|---|---|---|---|---|
| sample | protocol | factor | duration | method | Score |
| A-1b | 1b | 4 | 1.5 hour | None | 70 |
| A-1b | 1b | 4 | 1.5 hour | Beads | 83 |
| A-1b | 1b | 4 | 1.5 hour | Homogenizer | 88 |

The data presented in Table 7 demonstrate an increase in herbicidal activity when grinding source A powder, either by metal beads or by a homogenizer.

The effect of grinding methods on the extract herbicidal activity was further tested.

10 grams from Plant source A powder were grinded in a coffee grinder. After mixing the grinded powder with solution 1b it was homogenized for 3 minutes as described above (‘Homogenizer+ Coffee grinder’ in table 8 below). Additional extraction protocols included:
(i) grinded powder without homogenizing (‘Coffee grinder’ in table 8 below);
(ii) homogenizing without grinding (‘Homogenizer’ in table 8 below); and
(iii) no grinding and no homogenizing (‘None’ in table 8 below).

All solutions were then mixed for 1.5 hour before the final filtration step. Extracts were then diluted 5-fold using 2% MIPA, 2% DASH, and 0.25% Genapol solution. Herbicidal activity of the extracts was determined by post-emergence application on 8-day old plants (weeds) of the A. palmeri specie that was grown at 16 hours/8 hours day/night cycles at 30° C./25° C., respectively.

Each treatment contained five 100 cm² pots. Each pot contained about 6 A. palmeri plants and each was sprayed with 1 ml of the respective Rhein-containing extract sample. Herbicidal activity was assessed and scored 6 days after application, as described herein. Average activity scores are presented in Table 8 below.

TABLE 8

| Extract | Extraction | Dilution | Mixing | Grinding | A. palmeri |
|---|---|---|---|---|---|
| sample | protocol | factor | duration | method | Score |
| A-1b | 1b | 5 | 1.5 hour | None | 60 |
| A-1b | 1b | 5 | 1.5 hour | Homogenizer | 62 |
| A-1b | 1b | 5 | 1.5 hour | Coffee grinder | 66 |
| A-1b | 1b | 5 | 1.5 hour | Homogenizer + | 80 |
| | | | | Coffee grinder | |

The data presented in Table 8 demonstrate an increase in herbicidal activity when grinding source A powder, especially when grinding is combined with homogenizing.

### Example 3

### Net-House Study

In order to assess the herbicidal activity in a net-house experiment, an exemplary Rhein-containing extract was tested on a weed panel.

Herbicidal activity of the exemplary extract sample A-1b was determined by post-emergence application on 14-day old plants (weeds) of the Abutilon theophrasti, Echinochloa colonum, Amaranthus rudis and PS II-resistant (HRAC group 5, target-site resistant) Amaranthus rudis that were grown in a net-house. Average daily minimum and maximum temperatures during the assay were 17.5° C./45° C., respectively. Leaf stage was typically 1.5-2 for A. theophrasti, 4 for E. colonum, 3-4 for A. rudis, and 2-4 for PS II-resistant A. rudis.

In each treatment, one 100 cm² pot containing about 6 plants of each tested weed species, was sprayed with a 1 ml of the exemplary extract sample A-1b. Herbicidal activity was assessed and scored 4 days after application, as described herein. The scores are the average of three technical repeats, and are presented in Table 9 below.

TABLE 9

| Weed specie | Score |
|---|---|
| Abutilon theophrasti | 37 |
| Echinochloa colonum | 23 |
| Amaranthus rudis | 100 |
| PS II-resistant (HRAC group 5) | 97 |
| Amaranthus rudis | |

These results demonstrate the herbicidal activity of the exemplary Rhein-containing extract sample A-1b, also against herbicide-resistant weeds.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-51. (canceled)

52. A plant extract comprising an aqueous extraction medium and at least one anthraquinone compound extracted from the plant, wherein at least 50%, or at least 70%, or at least 80% of a total amount of said at least one anthraquinone consist of Rhein and/or a glycosylated derivative thereof.

53. The plant extract of claim 52, wherein said plant is selected from Rheum palmatum, Cassia fistula and Cassia angustifolia.

54. The plant extract of claim 52, obtainable from a root of Rheum palmatum; or a pulp of Cassia fistula; or a leaf of Cassia angustifolia.

55. The plant extract of claim 52, obtainable upon contacting said plant or a part thereof with said aqueous extraction medium.

56. The plant extract of claim 55, wherein said contacting is of a single plant or of a part of said single plant.

57. The plant extract of claim 55, wherein said aqueous extraction medium comprises a polar organic solvent.

58. The plant extract of claim 57, wherein said polar organic solvent is or comprises an amine-containing alcohol.

59. The plant extract of claim 58, wherein a concentration of said amine-containing alcohol in said aqueous extraction medium ranges from 0.1 to 10, or from 1 to 10, % by volume, of the total volume of the extraction medium.

60. The plant extract of claim 57, wherein said aqueous extraction medium further comprises at least one water-soluble or water-miscible organic solvent.

61. The plant extract of claim 60, wherein a total amount of said at least one solvent ranges from 1 to 20, or from 1 to 10, % by volume, of the total volume of the aqueous extraction medium.

62. The plant extract of claim 57, wherein said aqueous extraction medium further comprises at least one adjuvant.

63. The plant extract of claim 62, wherein a total amount of said at least one adjuvant ranges from 0.1 to 5, or from 1 to 5, or from 1 to 3%, by volume of the total volume of the aqueous solution.

64. A process of preparing a plant extract that comprises at least one anthraquinone and an aqueous extraction medium, wherein at least 50%, or at least 70%, or at least 80% of a total amount of said at least one anthraquinone consist of Rhein and/or a glycosylated derivative thereof, the process comprising contacting a plant or a part thereof with said aqueous extraction medium, wherein:
said contacting is with a root of Rheum palmatum with said aqueous extraction medium; and/or
said extraction medium comprising a polar organic solvent which further comprises an amine.

65. The process of claim 64, wherein said extraction medium comprises said polar organic solvent and further comprises at least one water-soluble or water-miscible organic solvent and/or at least one adjuvant.

66. The process of claim 64, wherein said contacting is with a single plant or with a part of a single part.

67. The process of claim 64, wherein said single plant is selected from Rheum palmatum, Cassia fistula and Cassia angustifolia.

68. The process of claim 67, wherein said contacting is with a root of Rheum palmatum; or a pulp of Cassia fistula, or a leaf of Cassia angustifolia.

69. A plant extract obtainable by the process of claim 64.

70. A composition comprising the plant extract of claim 52, and optionally further comprising an agriculturally acceptable carrier.

71. A composition comprising the plant extract of claim 69, and optionally further comprising an agriculturally acceptable carrier.

72. A method of controlling a growth of a herb or of controlling a growth of a plant substrate, the method comprising contacting the herb or the plant substrate or an environment thereof to thereby control a growth of a herb in the vicinity of the plant substrate, with a herbicidally effective amount of the plant extract of claim 52 or a composition comprising the plant extract and optionally an agriculturally acceptable carrier.

73. A method of controlling a growth of a herb or of controlling a growth of a plant substrate, the method comprising contacting the herb or the plant substrate or an environment thereof to thereby control a growth of a herb in the vicinity of the plant substrate, with a herbicidally effective amount of the plant extract of claim 69 or a composition comprising the plant extract and optionally an agriculturally acceptable carrier.
